(19) United States
(12) Patent Application Publication
(10) Pub. No.: US 2011/0283116 A1
(43) Pub. Date: Nov. 17, 2011

(54) STORAGE CONTROLLER AND POWER SAVING METHOD

(75) Inventor: Hiromasa Ban, Odawara (JP)

(73) Assignee: Hitachi Ltd.

(21) Appl. No.: 12/669,474

(22) PCT Filed: Aug. 10, 2009
(86) PCT No.: PCT/JP2009/003843

§ 371 Date: Jan. 15, 2010

(51) Int. Cl. G06F 3/06

(52) U.S. Cl. 713/300

(57) ABSTRACT

This invention proposes a storage controller and its power saving methods capable of significantly saving power consumption. The storage controller of this invention is connected to host terminals and storage devices, controls data storage in the storage devices, and includes a microprocessor including one or more ports and at the same time controlling the entire relevant device via the relevant ports, and multiple types of components including one or more ports and at the same time configuring data paths between the host terminals and the storage devices via the relevant ports, and the microprocessor detects, among the ports of the relevant microprocessor or the component, those not connected to any of the host terminals, any of the storage devices, or any of the ports of the other components as unconnected ports, and stops the power supply to the detected unconnected ports.

### TECHNICAL FIELD

This invention relates to a storage controller and its power saving methods, and can be suitably applied a management server for managing a storage system used in a computing system.

### BACKGROUND ART

Currently, due to the increasing capacity and speed of storage systems, the power consumption thereof is also increasing streadly.

Therefore, according to the technology disclosed in the Patent Document 1, a storage system includes disk devices for storing data for which a host computer issues a write request and a controller for controlling accesses to the disk devices. The controller includes an interface connected to the host computer via a network, a processor connected to the interface, and a memory connected to the processor. The processor measures the load on the storage system and saves power consumption by controlling the power supplies of the controller in accordance with the load.

Furthermore, the LSI (Large Scale Integration) used in the storage system also saves power consumption by partially stopping the clock by the clock gating technology.

### CITATION LIST

### Patent Literature

PTL 1: Patent Document 1 Japanese Patent Laid-Open Publication No. 2007-102409

### SUMMARY OF INVENTION

### Technical Problem

Meanwhile, the LSI makes use of a high-speed interface (port) such as PCI-Express which is mandatory for accelerating data transfer.

In this case, as the high-speed interface causes a large amount of leak current, the problem of increasing power consumption arises even if the above-mentioned technology is applied.

This invention is intended in view of the above-mentioned problems, and its object is to propose a storage controller and its power saving methods capable of significantly saving power consumption.

In order to achieve the foregoing object, the present invention provides a storage controller connected to a host terminal and a storage device for controlling data in the storage device. This storage controller comprises a plurality of components comprising one or more ports and configuring a data path between the host terminal and the storage device via the ports, and a microprocessor comprising one or more ports and for controlling the components via the ports. The microprocessor detects an unconnected port among the ports of the microprocessor or the component that is not connected to a port of the host terminal, the storage device, or another component, and stops the supply of power to the detected unconnected port.

Furthermore, the present invention also provides a power saving method of a storage controller for controlling data in a storage device and comprising a plurality of components comprising one or more ports and configuring a data path between the host terminal and the storage device via the ports, and a microprocessor comprising one or more ports and for controlling the components via the ports. The microprocessor comprises a step of detecting an unconnected port among the ports of the microprocessor or the component that is not connected to a port of the host terminal, the storage device, or another component; and a step of stopping the supply of power to the detected unconnected port.

This invention is able to achieve a storage controller and its power saving methods capable of significantly saving power consumption.

### BRIEF DESCRIPTION OF DRAWINGS

FIG. 1 is a diagram showing a schematic view of the configuration example of the computing system in this invention;

FIG. 2 is a diagram showing the detailed configuration example of a channel adapter package in this invention;

FIG. 3 is a diagram showing the detailed configuration example of a disk adapter package in this invention;

FIG. 4A is a diagram showing the detailed configuration example of a microprocessor in this invention;

FIG. 4B is a diagram showing the detailed configuration example of a cache memory package in this invention;

FIG. 5 is a diagram showing the detailed configuration example of an internal switch package in this invention;

FIG. 6A is a diagram showing the configuration example of an SVP all-devices configuration table included in the management terminal of this invention;

FIG. 6B is a diagram showing the configuration example of an SVP all-LSI ports configuration table included in the management terminal of this invention;

FIG. 7A is a diagram showing the configuration example of a microprocessor device configuration table included in the microprocessor of this invention;

FIG. 7B is a diagram showing the configuration example of a microprocessor LSI port management table included in the microprocessor of this invention;

FIG. 8 is a diagram showing the detailed configuration example of the mechanism for passing data signals synchronously with clock signals to one port in the switch LSI in this invention;

FIG. 9 is a diagram showing the detailed configuration example of the mechanism for supplying power to one port in the switch LSI in this invention;

FIG. 10 is a flowchart showing an overall flow example of creating a table performed by the microprocessor;

FIG. 11 is a diagram showing an operation included in the table creation processing;

FIG. 12 is a diagram showing an operation included in the table creation processing;

FIG. 13 is the first half of an overall flow example of the channel adapter package power supply disconnection processing performed by the microprocessor;

FIG. 14 is the latter half of an overall flow example of the channel adapter package power supply disconnection processing performed by the microprocessor;

FIG. 15A is an overall flow example of the channel adapter host connection confirmation processing performed by the channel adapter package;

FIG. 15B is an overall flow example of the channel adapter LSI linkup processing performed by the channel adapter LSI;

FIG. 16A is a diagram showing an operation in the channel adapter package power supply disconnection processing;

FIG. 16B is a diagram showing a configuration example of the microprocessor device configuration table created as a result of the channel adapter package power supply disconnection processing;

FIG. 17A is a diagram showing an operation in the channel adapter package power supply disconnection processing;

FIG. 17B is a diagram showing a configuration example of the microprocessor LSI port management table created as a result of the channel adapter package power supply disconnection processing;

FIG. 18 is the first half of an overall flow example of the disk adapter package power supply disconnection processing performed by the microprocessor;

FIG. 19 is the latter half of an overall flow example of the disk adapter package power supply disconnection processing performed by the microprocessor;

FIG. 20 is an overall flow example of the disk adapter host connection confirmation processing performed by the disk adapter package;

FIG. 21 is an overall flow example of the cache memory package power supply disconnection processing performed by the microprocessor;

FIG. 22A is a diagram showing an operation in the cache memory package power supply disconnection processing;

FIG. 22B is a diagram showing a configuration example of the microprocessor LSI port management table created as a result of the cache memory package power supply disconnection processing;

FIG. 23 is an overall flow example of the microprocessor power supply disconnection processing performed by the microprocessor;

FIG. 24 is the first half of an overall flow example of the internal switch package power supply disconnection processing performed by the microprocessor;

FIG. 25 is the latter half of an overall flow example of the internal switch package power supply disconnection processing performed by the microprocessor;

FIG. 26 is a diagram showing the operation for reflecting the information of the microprocessor device configuration table on the SVP all-devices configuration table;

FIG. 27 is a diagram showing the operation for reflecting the information of the microprocessor LSI port management table on the SVP all-LSI ports configuration table;

FIG. 28 is the first half of an overall flow example of the LSI power supply disconnection processing performed by each LSI;

FIG. 29 is the latter half of an overall flow example of the LSI power supply disconnection processing performed by each LSI;

FIG. 30 is a diagram showing the first half of the operation by the LSI for disconnecting power supply in the ports;

FIG. 31 is a diagram showing the latter half of the operation by the LSI for disconnecting power supply in the ports;

FIG. 32 is an overall flow example of the initial processing of removal performed by the SVP;

FIG. 33A is a diagram showing the operation for the initial processing in removal;

FIG. 33B is a diagram showing the operation for the initial processing in removal;

FIG. 34 is an overall flow example of the power supply disconnection processing in removal performed by the microprocessor;

FIG. 35 is an overall flow example of the initial processing of addition performed by the SVP;

FIG. 36A is a diagram showing the operation for the initial processing in addition;

FIG. 36B is a diagram showing the operation for the initial processing in addition;

FIG. 37 is the first half of an overall flow example of the power supply disconnection processing in addition performed by the microprocessor;

FIG. 38 is the latter half of an overall flow example of the power supply disconnection processing in addition performed by the microprocessor;

FIG. 39 is the first half of an overall flow example of the LSI power supply processing performed by each LSI; and

FIG. 40 is the latter half of an overall flow example of the LSI power supply processing performed by each LSI.

### BEST MODE FOR CARRYING OUT THE INVENTION

An embodiment of this invention is now described in detail with reference to the attached drawings. Note that the scope of this invention is not limited to this embodiment.

This embodiment describes the method by which a disk controller 1 detects unconnected internal ports and disconnects power supply in the detected unconnected ports.

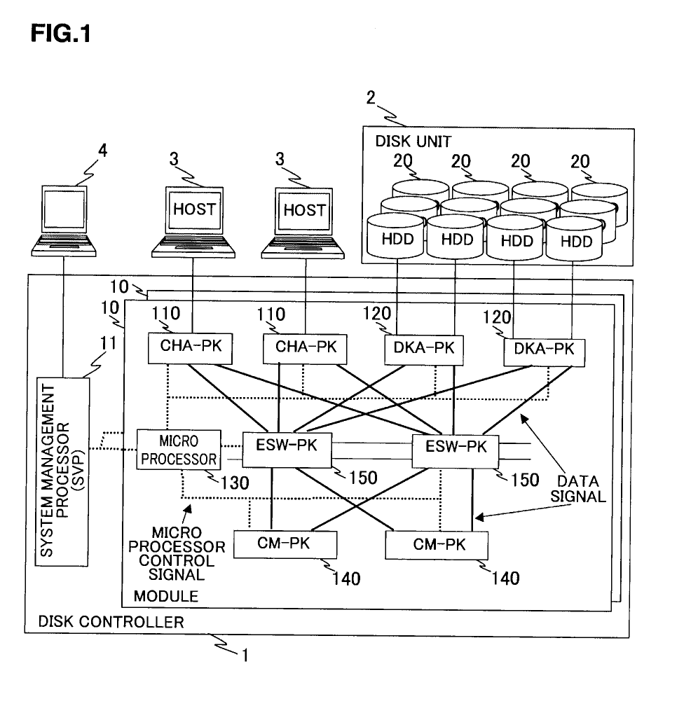

FIG. 1 shows the configuration of a disk controller 1. The disk controller 1 is connected to a disk unit 2, host terminals 3, and a management terminal 4. The disk controller 1 includes multiple modules 10 and a system management processor 11 (hereinafter referred to as an SVP 11).

Each of the multiple modules 10 includes multiple channel adapter packages 110 (hereinafter referred to as CHA-PKs 110), multiple disk adapter packages 120 (hereinafter referred to as DKA-PKs 120), a microprocessor 130, multiple cache memory packages 140 (hereinafter referred to as CM-PKs 140), and multiple internal switch packages 150 (hereinafter referred to as ESW-PKs 150).

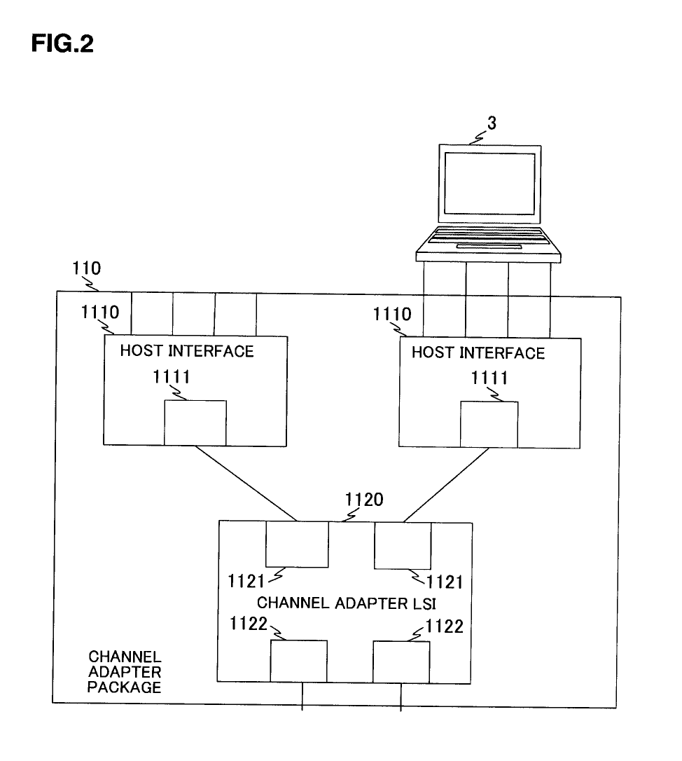

FIG. 2 shows the detailed configuration of a CHA-PK 110. The CHA-PK 110 includes multiple host interfaces 1110 and a channel adapter LSI 1120 (hereinafter referred to as a CHA-LSI 1120). The CHA-PK 110 includes the function of receiving and sending data input/output requests between the host terminals 3 and the microprocessor 130 and exchanging data with the host terminals 3.

A host interface 1110 can be connected to the host terminal 3, and includes a port 1111 to be connected to the CHA-LSI 1120. The host interface 1110 determines whether it is connected to the host terminal 3 and, if it determines it is not connected, disconnects the power supply in the port 1111.

If a connection confirmation signal is sent from another port while power is supplied and the power supply is on, in response, the port 1111 returns a signal that the connection is established. Meanwhile, if a connection confirmation signal is sent from another port while power is not supplied and the power supply is not on, no signal is returned.

The CHA-LSI 1120 controls the connection between the host interfaces 1110 and the ESW-PK 150. The CHA-LSI 1120 includes multiple ports 1121 connected to the host interfaces 1110 and multiple ports 1122 connected to the ESW-PK 150. The ports 1121, 1122 transmit connection confirmation signals to the other ports and, if no response signal is returned, disconnect power supply.

If a connection confirmation signal is sent from another port while power is supplied and the power supply is on, in response, the port 1122 returns a signal that the connection is established. Meanwhile, if a connection confirmation signal is sent from another port while power is not supplied and the power supply is not on, no signal is returned.

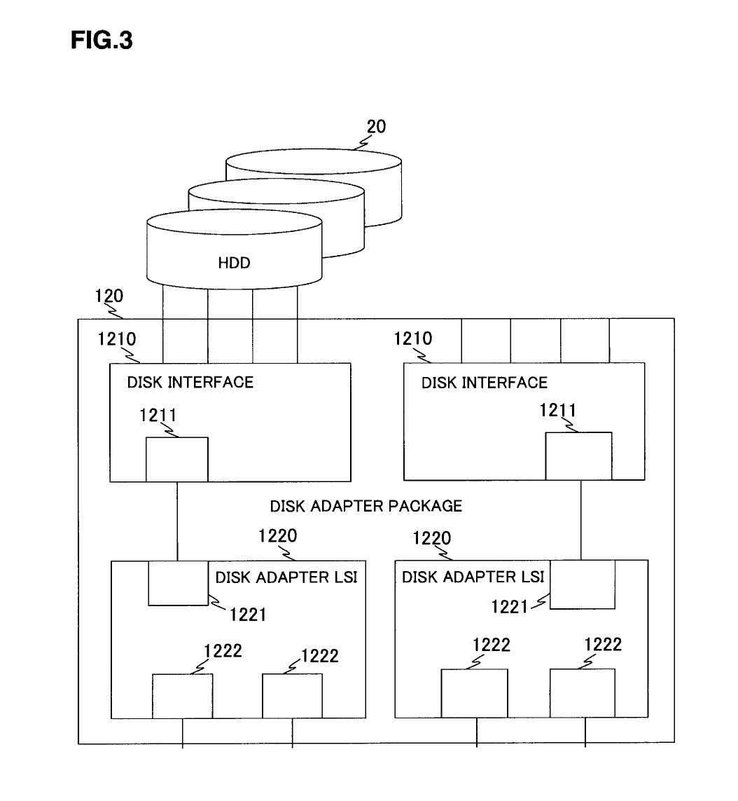

FIG. 3 shows the detailed configuration of a DKA-PK 120. The DKA-PK 120 includes multiple disk interfaces 1210 and disk adapter LSIs 1220 (hereinafter referred to as DKA-LSIs 1220). The DKA-PK 120 includes the function of receiving and sending data input/output requests among hard disks 20 in the disk unit 2 and the microprocessor 130 and exchanging data with the hard disks 20.

A disk interface 1210 can be connected to the hard disks 20, and includes a port 1211 to be connected to the DKA-LSI 1220. The disk interface 1210 determines whether it is connected to the hard disks 20 and, if it determines it is not connected, disconnects power supply in the port 1211.

If a signal for connection confirmation is sent from another port while power is supplied and the power supply is on, in response, the port 1211 returns a signal that the connection is established. Meanwhile, if a signal for connection confirmation is sent from another port while power is not supplied and the power supply is not on, no signal is returned.

The DKA-LSI 1220 controls the connection between the disk interfaces 1210 and the ESW-PK 150. The DKA-LSI 1220 includes ports 1221 connected to the disk interfaces 1210 and multiple ports 1222 connected to the ESW-PK 150.

The ports 1221, 1222 transmit signals for connection confirmation to the other ports and, if no response signal is returned, disconnect the power supply.

If a signal for connection confirmation is sent from another port while power is supplied and the power supply is on, in response, the ports 1222 return a signal that the connection is established. Meanwhile, if a signal for connection confirmation is sent from another port while power is not supplied and the power supply is not on, no signal is returned.

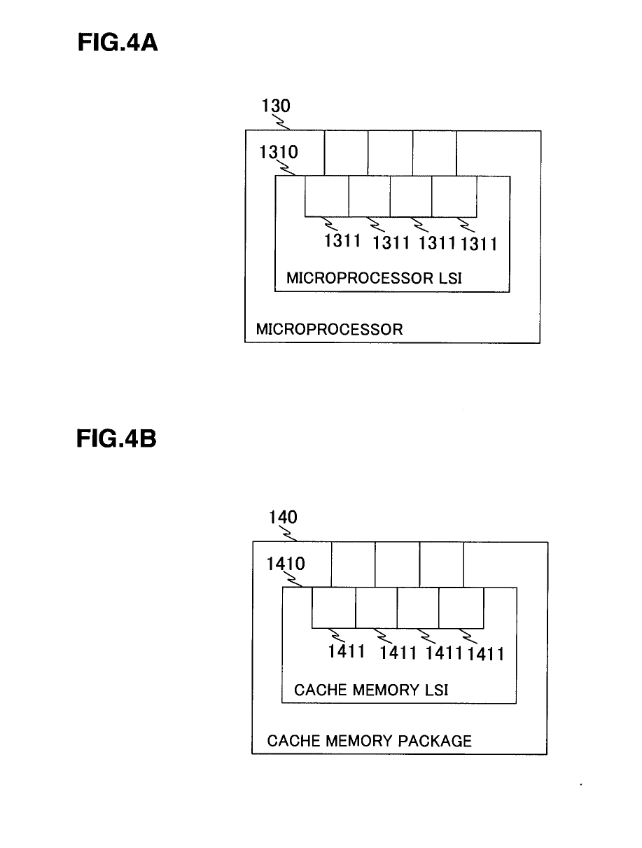

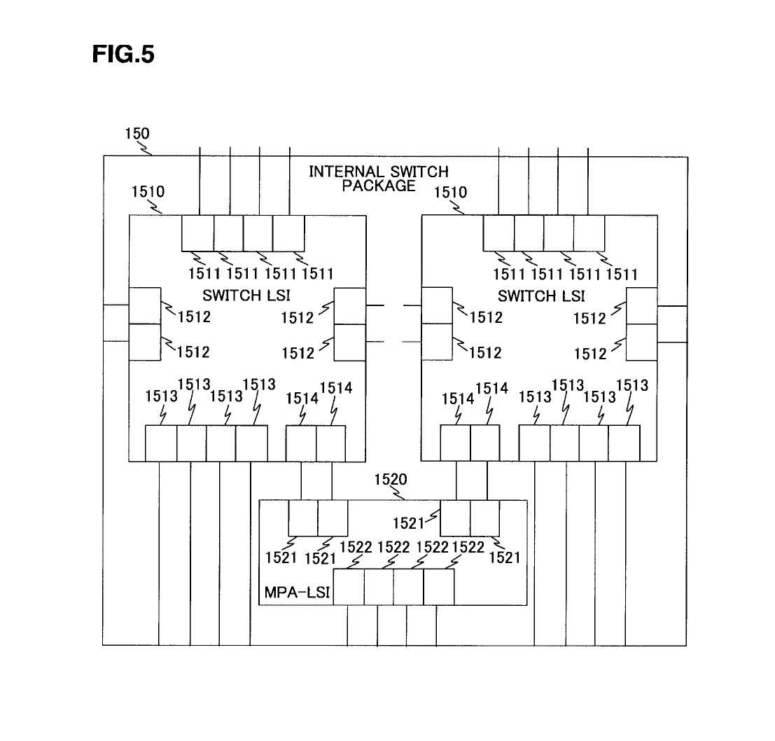

FIG. 4A shows the detailed configuration of the microprocessor 130. The microprocessor 130 includes a microprocessor LSI 1310 (hereinafter referred to as an MP-LSI 1310). The microprocessor 130 controls the entire module. As more specifically described, it controls accesses between the host terminals 3, the disk unit 2 and other components.

The MP-LSI 1310 includes ports 1311 connected to the microprocessor adapter LSI 1520 in the ESW-PK 150.

The ports 1311 transmit signals for connection confirmation to the other ports and, if no response signal is returned, disconnect the power supply.

If a signal for connection confirmation is sent from another port while power is supplied and the power supply is on, in response, the ports 1311 return a signal that the connection is established. Meanwhile, if a signal for connection confirmation is sent from another port while power is not supplied and the power supply is not on, no signal is returned.

FIG. 4B shows the detailed configuration of a CM-PK 140. The CM-PK 140 includes a cache memory LSI 1410 (hereinafter referred to as a CM-LSI 1410). The CM-PK 140 temporarily stores data when reading and writing data.

The MP-LSI 1310 is, for example, an SRAM (Static Random Access Memory), and includes ports 1411 connected to the switch LSI 1510 in the ESW-PK 150.

The ports 1411 transmit signals for connection confirmation to the other ports and, if no response signal is returned, disconnect the power supply.

If a signal for connection confirmation is sent from another port while power is supplied and the power supply is on, in response, the ports 1411 return a signal that the connection is established. Meanwhile, if a signal for connection confirmation is sent from another port while power is not supplied and the power supply is not on, no signal is returned.

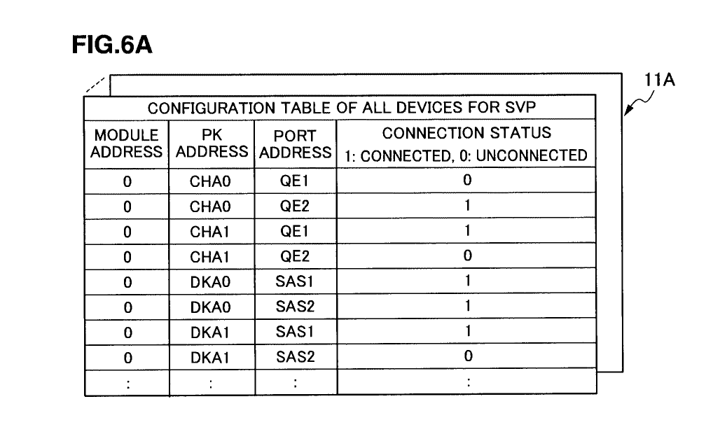

FIG. 5 shows the detailed configuration of the ESW-PK 150. The ESW-PK 150 includes multiple switch LSIs 1510 (hereinafter referred to as SW-LSIs 1510) and a microprocessor adapter LSI 1520 (hereinafter referred to as an MPA-LSI 1520). The ESW-PK 150 performs switching among the packages.

The SW-LSI 1510 includes ports 1511 connected to the CHA-LSI 1120 or the DKA-LSI 1220, ports 1512 connected to the other SW-LSIs 1510, ports 1513 connected to the CM-LSI 1410, and ports 1514 connected to the MPA-LSI 1520.

The ports 1511 to 1514 transmit signals for connection confirmation to the other ports and, if no response signal is returned, disconnect the power supply.

If a signal for connection confirmation is sent from another port while power is supplied and the power supply is on, in response, the ports 1511 to 1514 return a signal that the connection is established. Meanwhile, if a signal for connection confirmation is sent from another port while power is not supplied and the power supply is not on, no signal is returned.

The SVP 11 controls all the modules 10. Furthermore, the SVP 11 is a computer device for managing and monitoring the DKC 1 and the DKC 2 and provides the server functions for management. The administrator can perform, by logging into the SVP 11 via the management terminal 4, for example, the setting of the RAID configuration, the blockade processing of various types of packages (channel adapter packages, disk adapter packages, cache memory packages, etc.) and other types of setting changes, within the authorized scope.

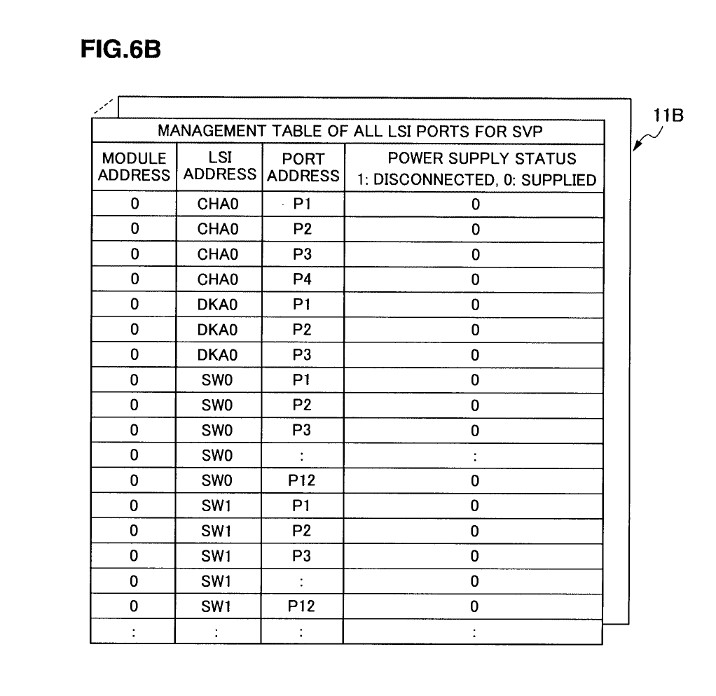

The SVP 11 stores the SVP all-devices configuration table 11A shown in FIG. 6A and the SVP all-LSI ports configuration table 11B shown in FIG. 6B.

The SVP all-devices configuration table 11A is configured of the module address field for the address allocated to each module, the PK address field for the address allocated to each package, the port address field for the address allocated to each port, and the connection status (connected or unconnected) field for the port input by the user.

The SVP all-LSI ports configuration table 11B is configured of the module address field for the address allocated to each module, the LSI address field for the address allocated to each LSI, the port address field for the address allocated to each port, and the connection status (connected or unconnected) field for the port input by the user.

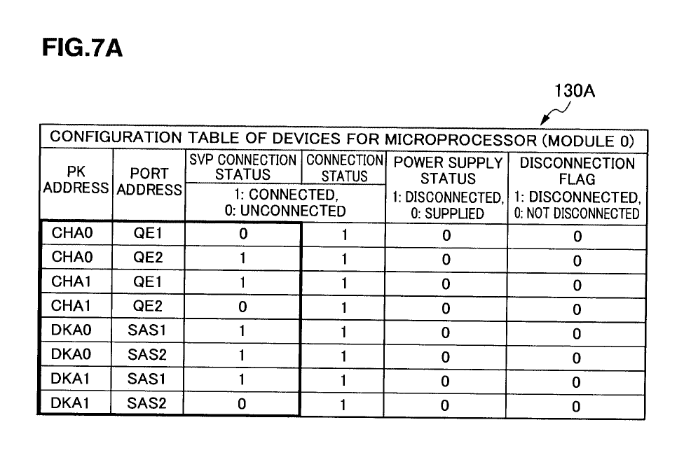

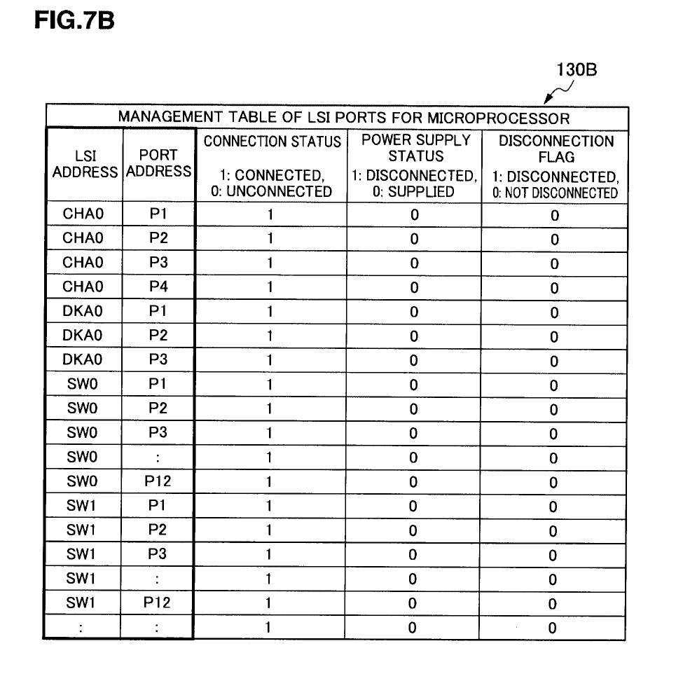

Furthermore, the microprocessor 130, in its registers (not included in the Figure), creates the microprocessor device configuration table 130A shown in FIG. 7A and the microprocessor LSI port management table 130B shown in FIG. 7B.

The microprocessor device configuration table 130A is configured of the PK address field for the address allocated to each package, the port address field for the address allocated to each port, the connection status (connected or unconnected) field for the port input by the user via the SVP 11, the actual connection status (connected or unconnected) field, the power supply status (disconnected or supplied) field of the port, and the disconnection flag (disconnected or not disconnected) field.

The microprocessor LSI port management table 130B is configured of the LSI address field for the address allocated to each LSI, the port address field for the address allocated to each port, the connection status (connected or unconnected) field for the port input by the user via the SVP 11, the actual connection status (connected or unconnected) field, the power supply status (disconnected or supplied) field of the port, and the disconnection flag (disconnected or not disconnected) field.

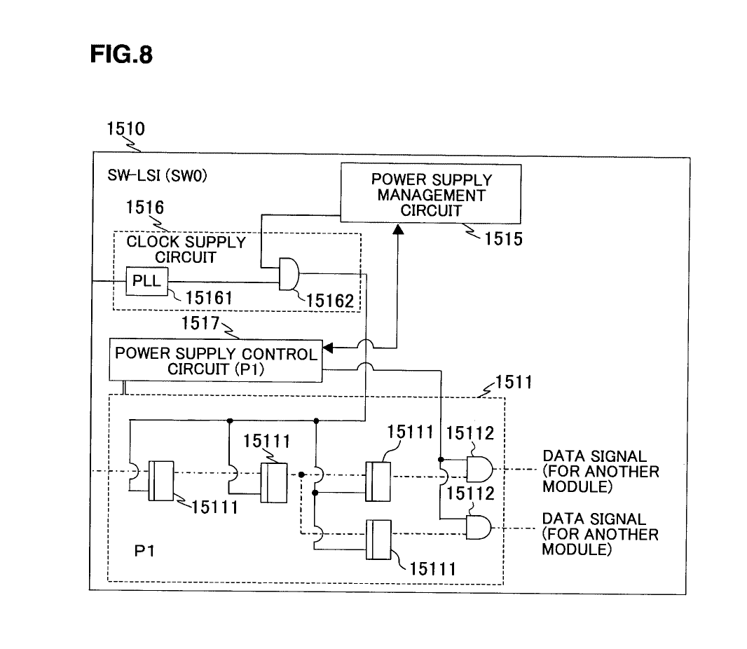

FIG. 8 is a diagram showing the mechanism for passing data signals synchronously with clock signals to ports 1511 in the SW-LSI 1510 as an example of the mechanism for passing data signals synchronously with clock signals to each port of each LSI. The SW-LSI 1510 includes a power supply management circuit 1515, a clock supply circuit 1516, and a power supply control circuit for each port. For example, for the port 1511 of the LSI address “SW0” and the port address “P1,” the exclusive power supply control circuit 1517 is attached.

The power supply management circuit 1515 controls the clock supply circuit 1516, and supplies clock signals to all the ports in the LSI or disconnects the supply. The power supply management circuit 1515 then controls the power supply control circuit of each port for inhibiting the output of data signals from the ports. The power supply management circuit 1515 controls the power supply control circuit for each port and disconnects the power supply for the port.

The clock supply circuit 1516 distributes clock signals to all the ports in the SW-LSI 1510. The clock supply circuit 1516 includes a PLL (Phase-locked loop) circuit 15161 and an AND gate 15162.

The PLL (Phase-locked loop) circuit 15161 converts a clock signal supplied from the clock input unit (not included in the Figure) into another clock signal of an arbitrary frequency, and outputs it to the AND gate 15162.

If a signal at the higher level than the power supply management circuit 1515 is input, the AND gate 15162 outputs the clock signal input by the PLL circuit 15161 as is and, if a signal at the lower level than the power supply management circuit 1515 is input, disconnects the clock signal input by the PLL circuit 15161.

The power supply control circuit 1517 is an exclusive circuit for the port 1511, inhibits the output of data signals from the port 1511 under the control of the power supply management circuit 1515, and disconnects the power supply for the port 1511.

The port 1511 includes multiple D-flip-flop circuits 15111 (hereinafter referred to as FF circuits 15111) and an AND gate 15112.

For the FF circuits 15111, clock signals are input from the clock supply circuit 1516, and data signals are input from the other ports, synchronizes the data signals with the clock signals, and outputs them.

If a signal at the higher level than the power supply management circuit 1517 is input, the AND gate 15112 transmits the data signal to another module and, if a signal at the lower level than the power supply management circuit 1517 is input, disconnects the data signal.

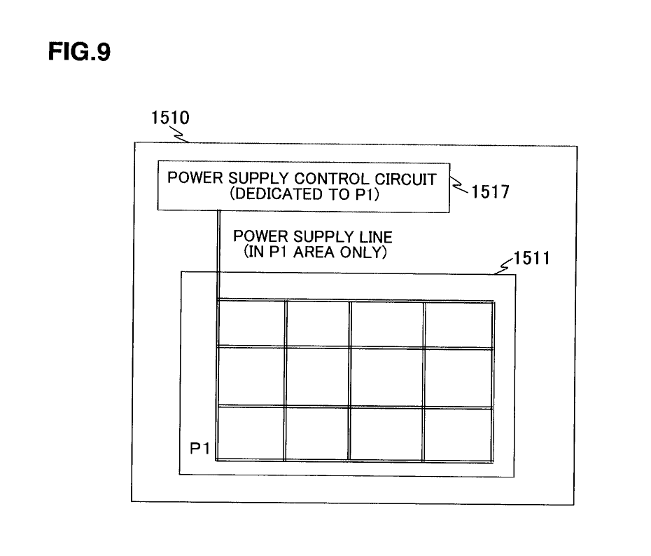

FIG. 9 is a diagram showing the detailed configuration example of the mechanism for supplying power to one port 1511 in the switch LSI 1510 as an example of the mechanism for supplying power to each port in each LSI. The power supply control circuit 1517 supplies power to each component in the port 1511 via the power supply line shown in FIG. 9.

The disk unit 2 includes multiple hard disks 20.

The operation of the disk controller 1 of the above-mentioned configuration is described below.

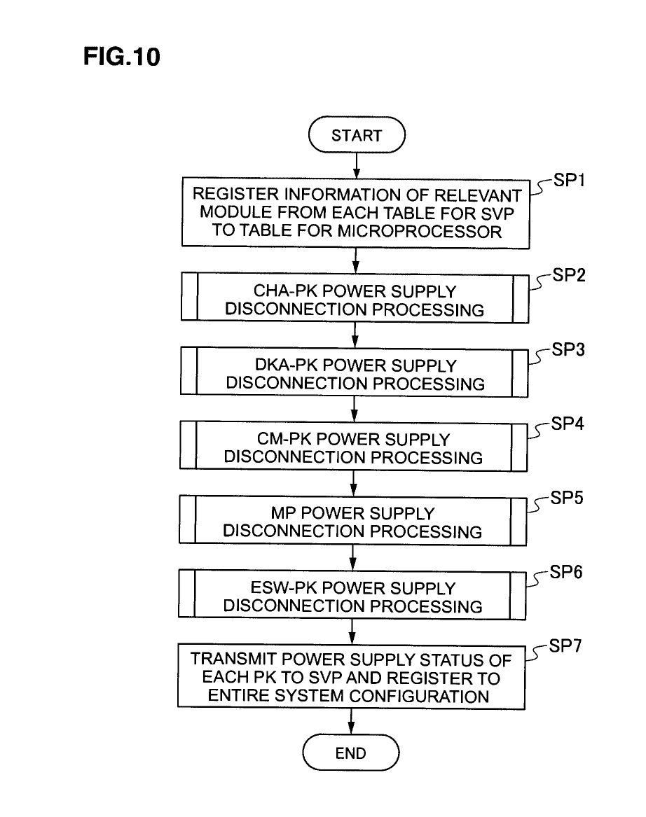

FIG. 10 is a flowchart for the table creation processing by the microprocessor 130 for creating the SVP all-devices configuration table 11A and the SVP all-LSI ports configuration table 11B.

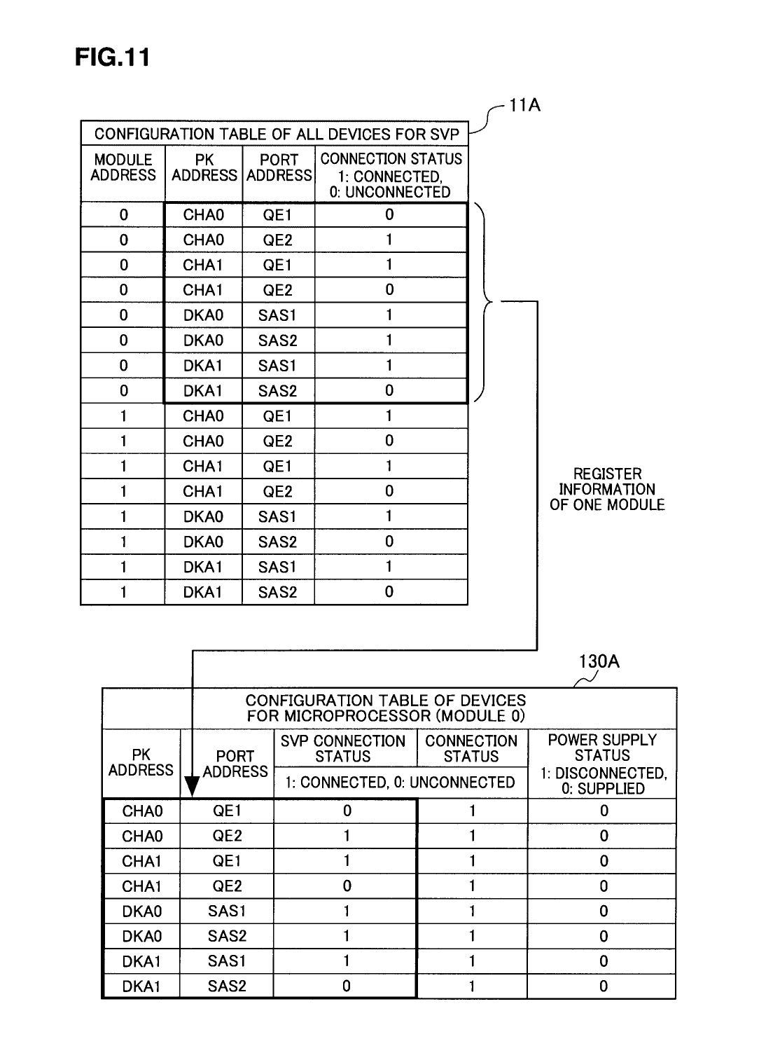

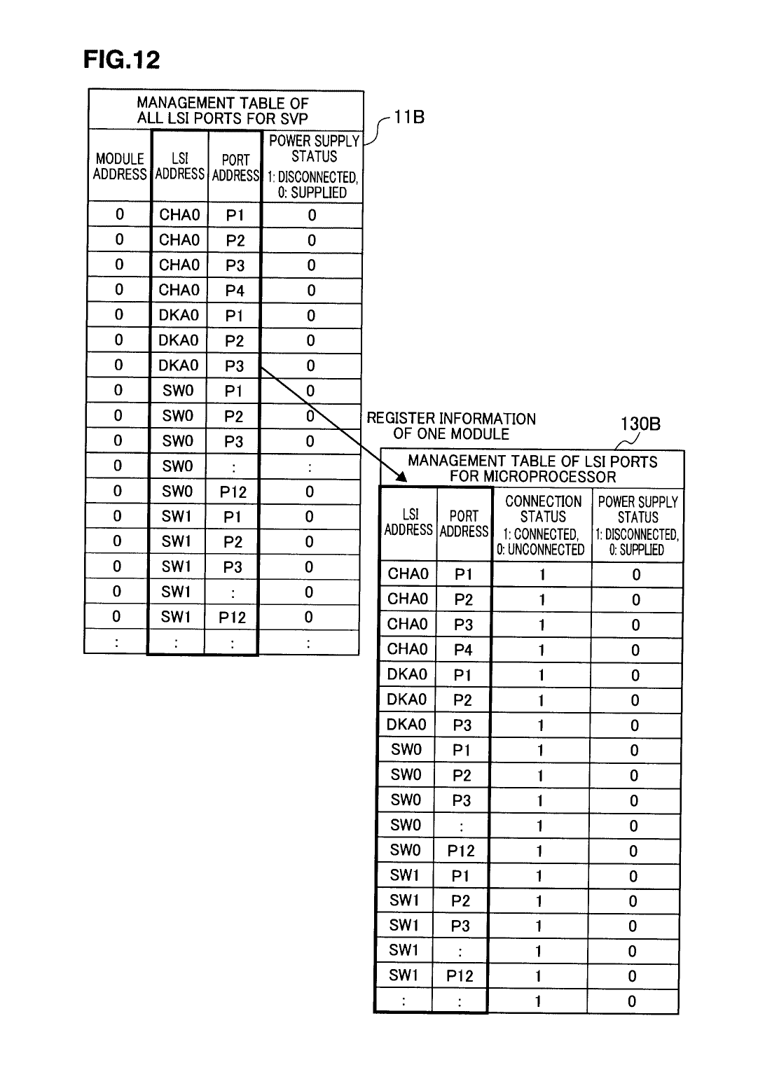

When newly starting up a DKC 1, each microprocessor 130 obtains information on the module 10 where the microprocessor 130 is installed from the SVP all-devices configuration table 11A and the SVP all-LSI ports configuration table 11B stored by the SVP 11 (SP 1). For example, as shown in FIG. 11, the microprocessor 130 installed in the module 10 of the module address “0” refers to the SVP all-devices configuration table 11A, and registers the PK address, the port address, and the connection status of the module address “0” in the PK address field, the port address field, and the SVP connection status field of the microprocessor device configuration table 130A respectively. Note that, at this time, the initial value of the connection status field is set to “1: Connected” and the initial value of the power supply status field is set to “0: Supplied.” Furthermore, as shown in FIG. 12, by referring to the SVP all-LSI ports configuration table 11B, the LSI address and the port address of the module address “0” are registered in the LSI address field and the port address field of the microprocessor LSI port management table 130B. Note that, at this time, the initial value of the connection status field is set to “1: Connected” and the initial value of the power supply status field is set to “0: Supplied.”

Next, the microprocessor 130 performs the CHK-PK power supply disconnection processing to be described later (SP 2). To be briefly described, this is the processing of detecting unconnected ports in the CHA-PK 110 and disconnecting the power supply of the detected unconnected ports.

The microprocessor 130 performs the DKA-PK power supply disconnection processing to be described later (SP 3). To be briefly described, this is the processing of detecting unconnected ports in the DKA-PK 120 and disconnecting the power supply of the detected unconnected ports.

The microprocessor 130 performs the CM-PK power supply disconnection processing to be described later (SP 4). To be briefly described, this is the processing of detecting unconnected ports in the CM-PK 140 and disconnecting the power supply of the detected unconnected ports.

The microprocessor 130 performs the MP power supply disconnection processing to be described later (SP 5). To be briefly described, this is the processing of detecting unconnected ports in the microprocessor 130 and disconnecting the power supply of the detected unconnected ports.

The microprocessor 130 performs the ESW-PK power supply disconnection processing to be described later (SP 6). To be briefly described, this is the processing of detecting unconnected ports in the ESW-PK 150 and disconnecting the power supply of the detected unconnected ports.

The microprocessor 130 transmits the information of the port for whose power supply is disconnected by the above-mentioned processing to the SVP 11, registers the information in the SVP all-devices configuration table 11A and the SVP all-LSI ports configuration table 11B (SP 7), and completes the processing.

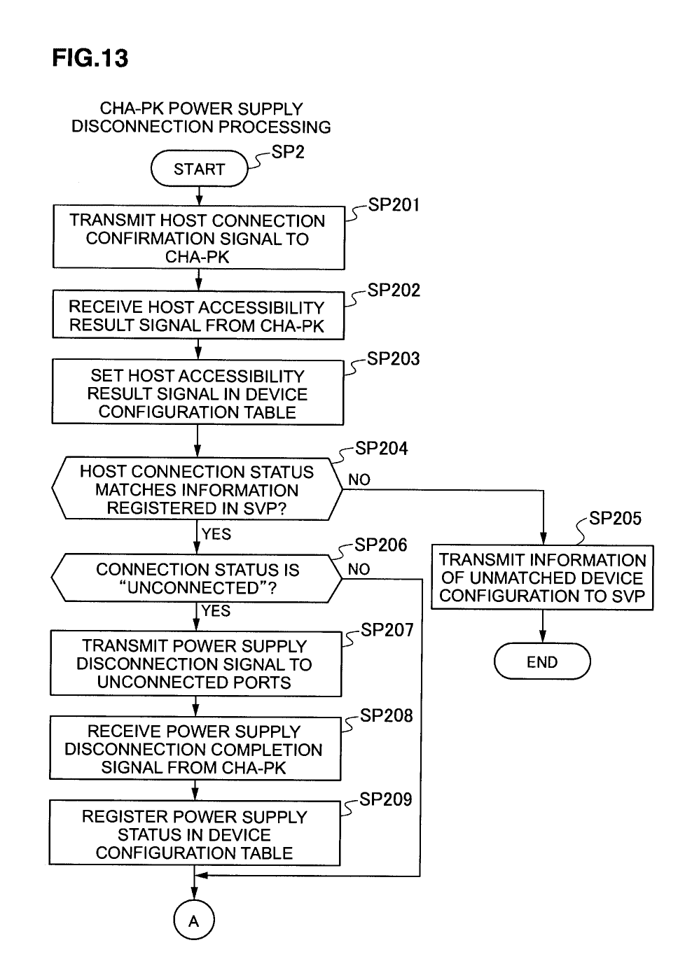

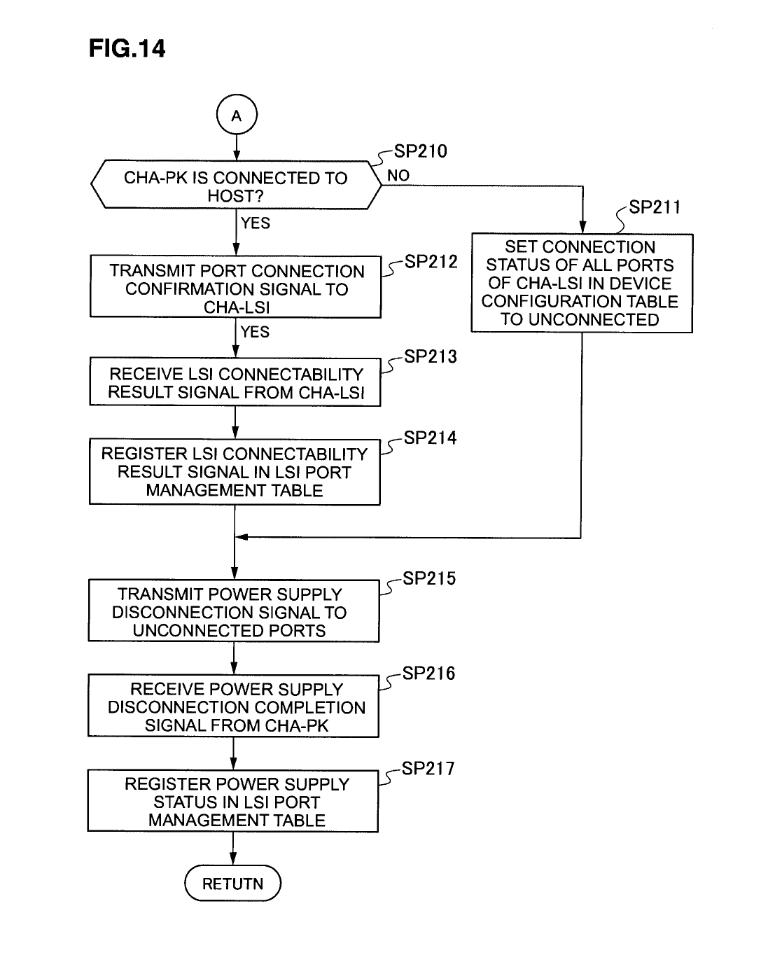

Next, the above-mentioned CHK-PK power supply disconnection processing (SP 2) is described in details with reference to FIGS. 13 and 14.

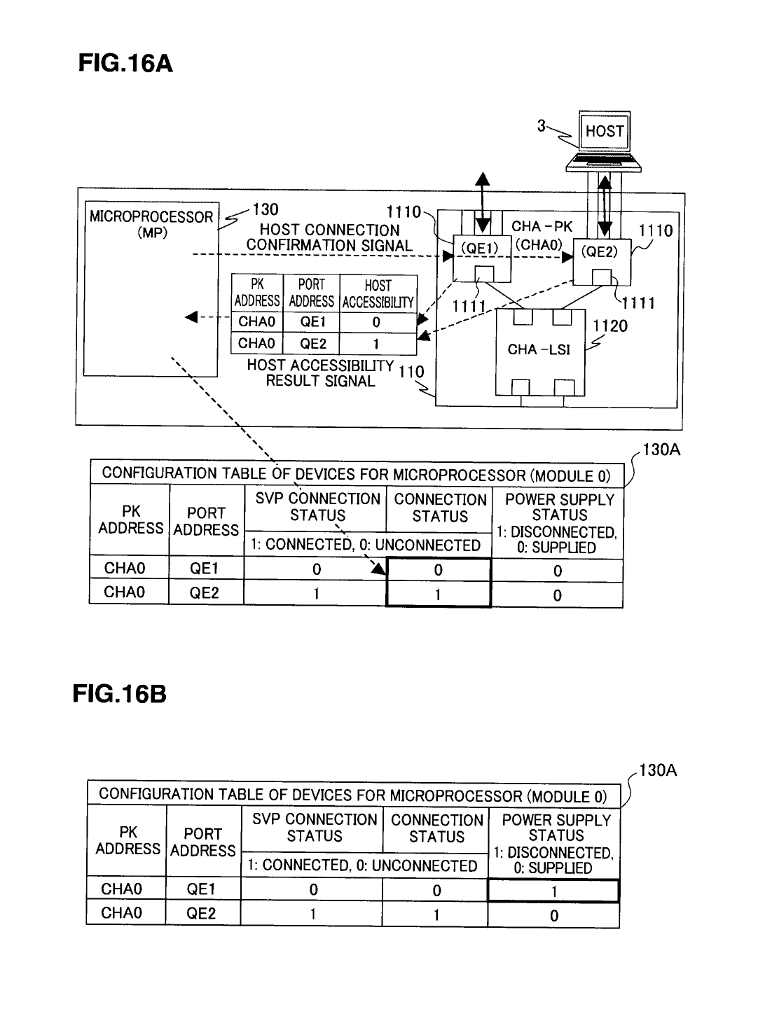

Firstly, the microprocessor 130, as shown in FIG. 16A, transmits a host connection confirmation signal for confirming whether the host interfaces of the CHA-PK 110 are connected to the host terminal 3 to the CHA-PK 110 (SP 201). The CHA-PK 110, as shown in FIG. 16A, when receiving a host connection confirmation signal, causes each host interface 1110 to confirm the connection to the host terminal 3, and transmits the host accessibility result signal based on the result to the microprocessor 130. The details of this processing are described later (CHA-host connection confirmation processing).

The microprocessor 130 receives the host accessibility result signal (SP 202) and, with reference to the signal, registers the information on whether the host interfaces 1110 are connected to the host terminal 3 in the connection status field of the microprocessor device configuration table 130A (SP 203).

The microprocessor 130 determines whether the information in the SVP connection status field matches the information in the connection status field in the microprocessor device configuration table 130A (SP 204).

If the two pieces of information do not match (SP 204; NO), the microprocessor 130 transmits the information of the unmatched device configuration showing that the device configuration input by the user does not match the actual device configuration to the SVP 11, reports it to the user, and completes the processing.

If the two pieces of information match (SP 204; YES), the microprocessor 130 determines whether there are any ports whose connection status is “unconnected” (SP 206).

If there is no port whose connection status is “unconnected” (SP 206; NO), the processing proceeds to SP 210.

If there are any ports whose connection status is “unconnected” (SP 206; YES), the microprocessor 130 transmits a power supply disconnection signal to each unconnected port (SP207). The CHA-PK 110 including the unconnected ports, when receiving the power supply disconnection signal, disconnects the power supply in the unconnected ports and transmits a power supply disconnection completion signal to the microprocessor 130.

The microprocessor 130 receives the power supply disconnection completion signal (SP 208) and, as shown in FIG. 16B, sets the power supply status field in the microprocessor device configuration table 130A to “1: Disconnected” (SP 209).

The microprocessor 130 determines whether the CHA-PK 110 is connected to the host terminals 3 (SP 210), that is, determines whether there are any host interfaces 1110 connected to the host terminals 3 included in the CHA-PK 110.

If there is no connection included in the CHA-PK 110 to the host terminals 3 (SP 210; NO), the microprocessor 130 sets the connection status field of all the ports in this CHA-PK 110 in the microprocessor device configuration table 130A microprocessor LSI port management table to “0: Unconnected” (SP 211), and proceeds to SP 215.

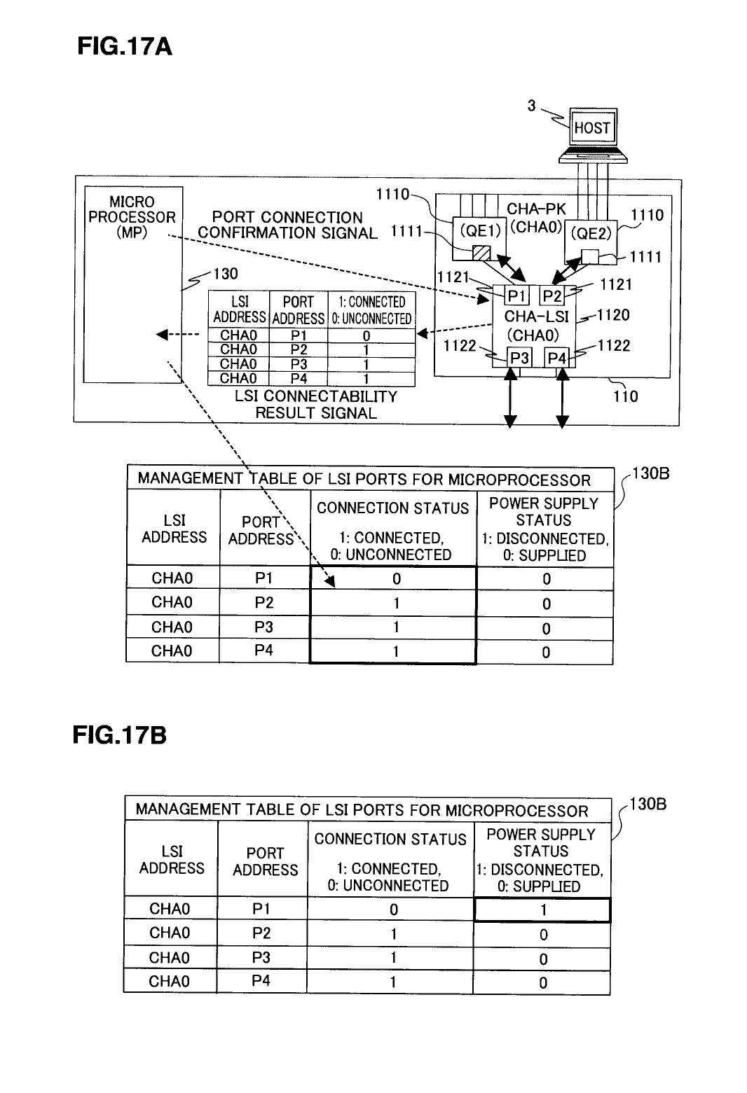

If there is any connection included in the CHA-PK 110 to the host terminals 3 (SP 210; YES), the microprocessor 130, as shown in FIG. 17A, transmits a port connection confirmation signal to the CHA-LSI 1120 (SP 212).

As shown in FIG. 17A, when receiving the port connection confirmation signal, the CHA-LSI 1120 causes the ports included in the relevant LSI to confirm the connection, and transmits an LSI connectibility result signal showing the result. The details of this processing are described later (CHA-LSI linkup processing).

The microprocessor 130, as shown in FIG. 17A, receives the LSI connectibility result signal (SP 213) and, with reference to the signal, registers the information on whether any ports in the CHA-LSI 1120 are connected to the other ports in the connection status field of the microprocessor LSI port management table (SP 214).

The microprocessor 130 transmits a power supply disconnection signal to the unconnected ports in the CHA-LSI 1120 (SP 215). The CHA-LSI 1120 including the unconnected ports, when receiving the power supply disconnection signal, disconnects the power supply in the unconnected ports, and transmits a power supply disconnection completion signal to the microprocessor 130.

The microprocessor 130 receives the power supply disconnection completion signal (SP 216) and, as shown in FIG. 17B, sets the power supply status field for the unconnected ports in the microprocessor LSI port management table 130B to “1; Disconnected” (SP 217), and the processing returns to the table creation processing.

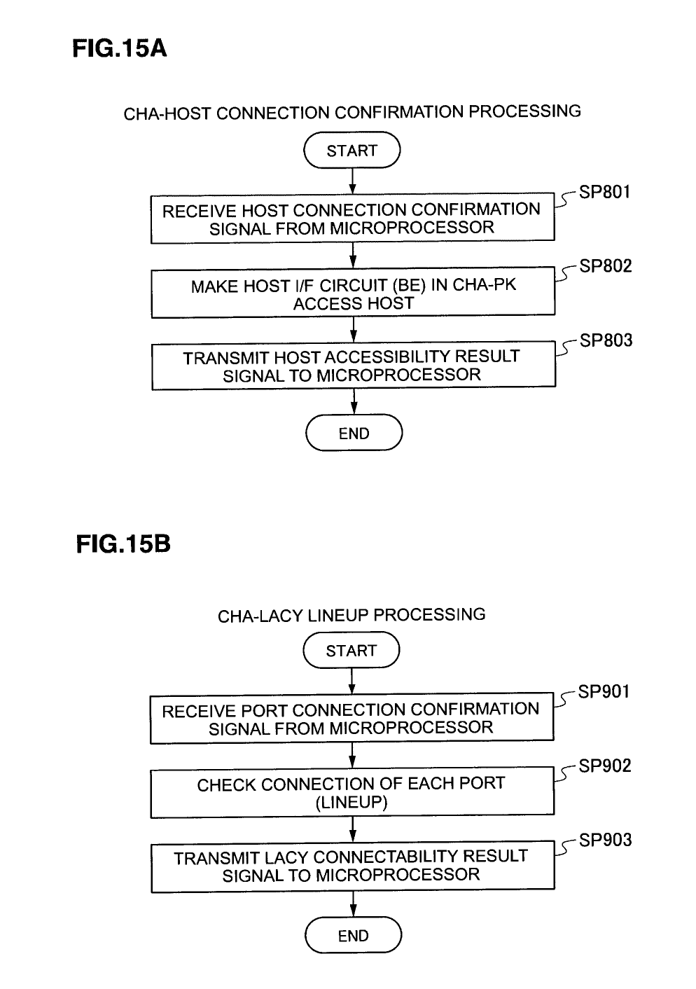

Next, the CHA-host connection confirmation processing is described with reference to FIG. 15A.

The CHA-PK 110, when receiving the host connection confirmation signal from the microprocessor 130 (SP 801), causes each host interface 1110 in the relevant package to access the host terminal 3, and confirms whether it is connected to the host terminal 3 (SP 802). The CHA-PK 110 transmits a host accessibility result signal showing the result of the confirmation to the microprocessor 130 (SP 803), and completes the processing.

Next, the CHA-LSI linkup processing is described with reference to FIG. 15B.

The CHA-LSI 1120, when receiving the port connection confirmation signal from the microprocessor 130 (SP 901), causes each port in the relevant LSI to transmit a signal to the other ports for confirming the connection, and confirms the ports which return the signal in response to the signal as the connected ports and the ports which do not return the signal as the unconnected ports (SP 902). The CHA-LSI 1120 transmits an LSI connectibility result signal showing the result of the confirmation to the microprocessor 130 (SP 903), and completes the processing.

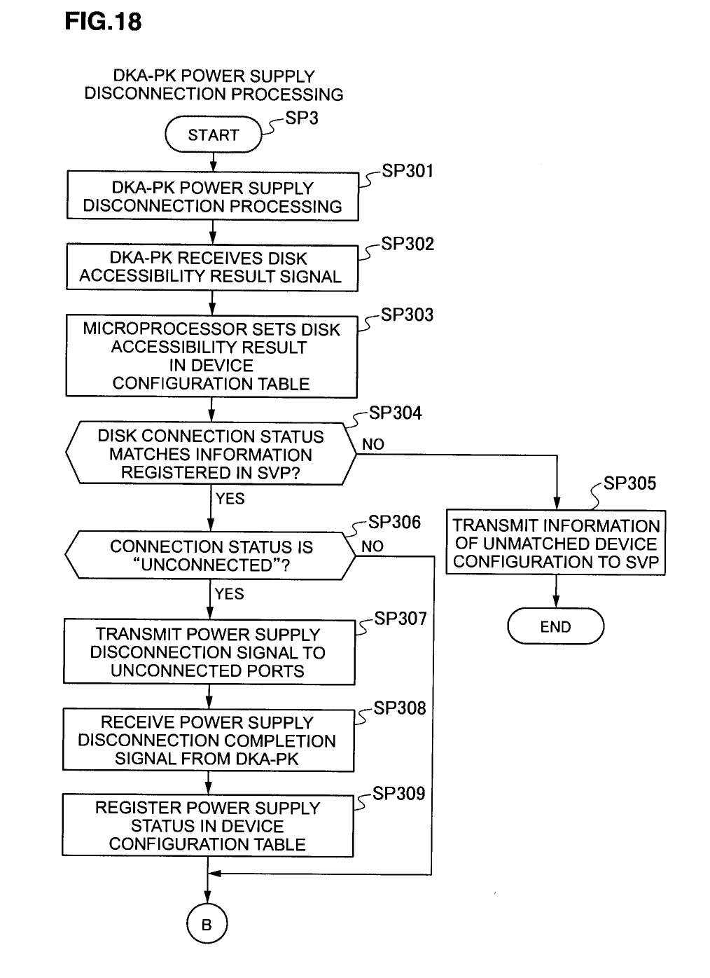

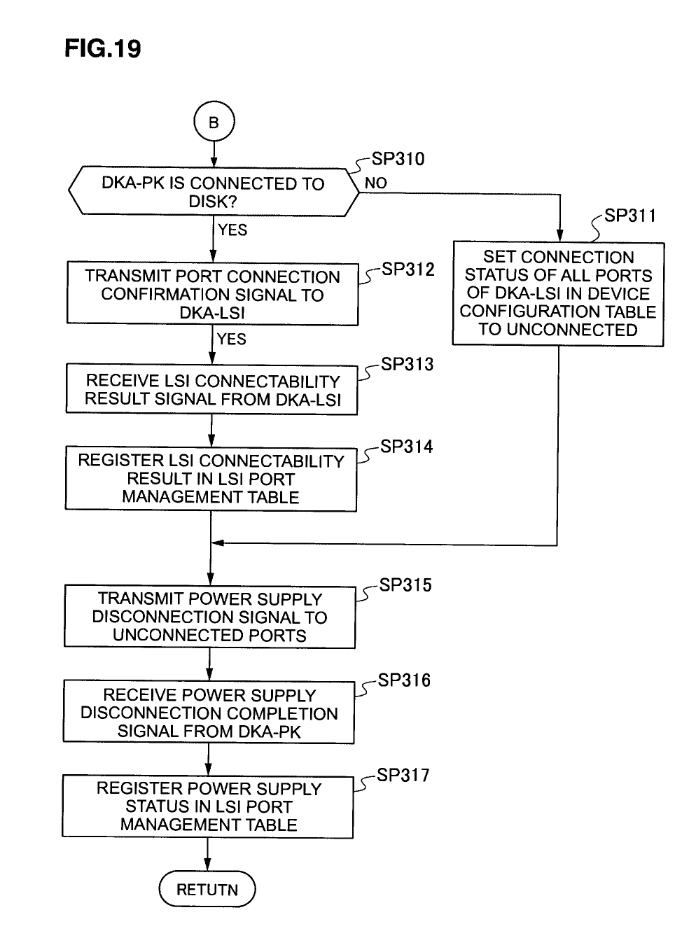

Next, the above-mentioned DKA-PK power supply disconnection processing (SP 3) is described in details with reference to FIGS. 18 and 19.

Firstly, the microprocessor 130 transmits a disk connection confirmation signal for confirming whether the disk interfaces 1210 of the DKA-PK 120 are connected to the hard disks 20 (SP 301) to the DKA-PK 120. The DKA-PK 120, when receiving the disk connection confirmation signal, causes each disk interface 1210 to confirm the connection to the hard disks 20, and transmits the disk accessibility result signal based on the result to the microprocessor 130. The details of this processing are described later (DKA-device connection confirmation processing).

The microprocessor 130 receives the disk accessibility result signal (SP 302) and, with reference to the signal, registers the information on whether the disk interfaces 1210 are connected to the hard disks 20 in the connection status field of the microprocessor device configuration table 130A (SP 303).

The microprocessor 130 determines whether the information in the SVP connection status field matches the information in the connection status field in the microprocessor device configuration table 130A (SP 304).

If the two pieces of information do not match (SP 304; NO) the microprocessor 130 transmits the information of the unmatched device configuration that the device configuration input by the user does not match the actual device confirmation to the SVP 11, reports it to the user, and completes the processing.

If the two pieces of information match (SP 304; YES), the microprocessor 130 determines whether there are any ports whose connection status is “unconnected” (SP 306).

If there is no port whose connection status is “unconnected” (SP 306; NO), the processing proceeds to SP 310.

If there are any ports whose connection status is “unconnected” (SP 306; YES), the microprocessor 130 transmits a power supply disconnection signal to the unconnected ports (5P307). The DKA-PK 120 including the unconnected ports, when receiving the power supply disconnection signal, disconnects the power supply in the unconnected ports and transmits a power supply disconnection completion signal to the microprocessor 130.

The microprocessor 130 receives the power supply disconnection completion signal (SP 308), and sets the power supply status field of the unconnected ports in the microprocessor device configuration table 130A to “1: Disconnected” (SP 309).

The microprocessor 130 determines whether the DKA-PK 120 is connected to the hard disks 20 (SP 310), that is, determines whether there are any disk interfaces 1210 connected to the hard disks 20 included in the DKA-PK 120.

If there is no connection included in the DKA-PK 120 to the hard disks 20 (SP 310; NO), the microprocessor 130 sets the connection status field of all the ports in this DKA-LSI 1220 in the microprocessor device configuration table 130A microprocessor LSI port management table to “0: Unconnected” (SP 311), and proceeds to SP 315.

If there is any connection included in the DKA-PK 120 to the hard disks 20 (SP 310; YES), the microprocessor 130 transmits a port connection confirmation signal to the DKA-LSI 1220 (SP 312). The DKA-LSI 1220, when receiving the port connection confirmation signal, causes the ports included in the relevant LSI to confirm the connection, and transmits an LSI connectibility result signal showing the result. This processing is omitted from the description here as it is the same as the CHA-LSI linkup processing.

The microprocessor 130 receives the LSI connectibility result signal (SP 313) and, with reference to the signal, registers the information on whether any ports in the DKA-LSI 1220 are connected to the other ports in the connection status field of the microprocessor LSI port management table (SP 314).

The microprocessor 130 transmits a power supply disconnection signal to the unconnected ports in the DKA-LSI 1220 (SP 315). The DKA-LSI 1220 including the unconnected ports, when receiving the power supply disconnection signal, disconnects the power supply in the unconnected ports, and transmits a power supply disconnection completion signal to the microprocessor 130.

The microprocessor 130 receives the power supply disconnection completion signal (SP 316), and sets the power supply status field for the unconnected ports in the microprocessor LSI port management table 130B to “1: Disconnected” (SP 317), and the processing returns to the table creation processing.

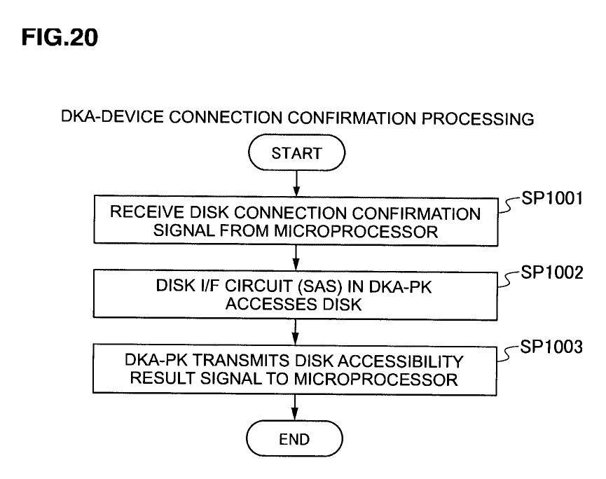

Next, the DKA-device connection confirmation processing is described with reference to FIG. 20.

The DKA-PK 120, when receiving the disk connection confirmation signal from the microprocessor 130 (SP 1001), causes each disk interface 1210 in the relevant package to access the hard disks 20, and confirms whether it is connected to the hard disks 20 (SP 1002). The DKA-PK 120 transmits a disk accessibility result signal showing the result of the confirmation to the microprocessor 130 (SP 1003), and completes the processing.

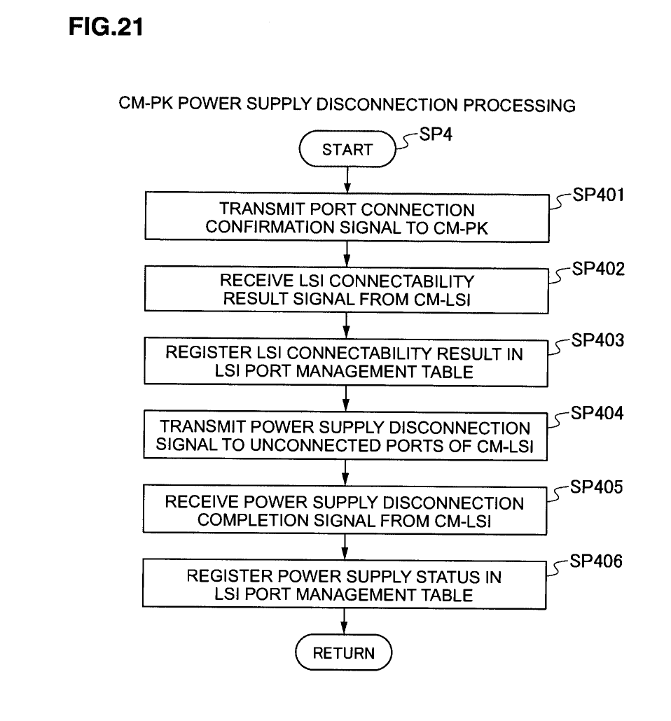

Next, the above-mentioned CM-PK power supply disconnection processing (SP 4) is described in details with reference to FIG. 21.

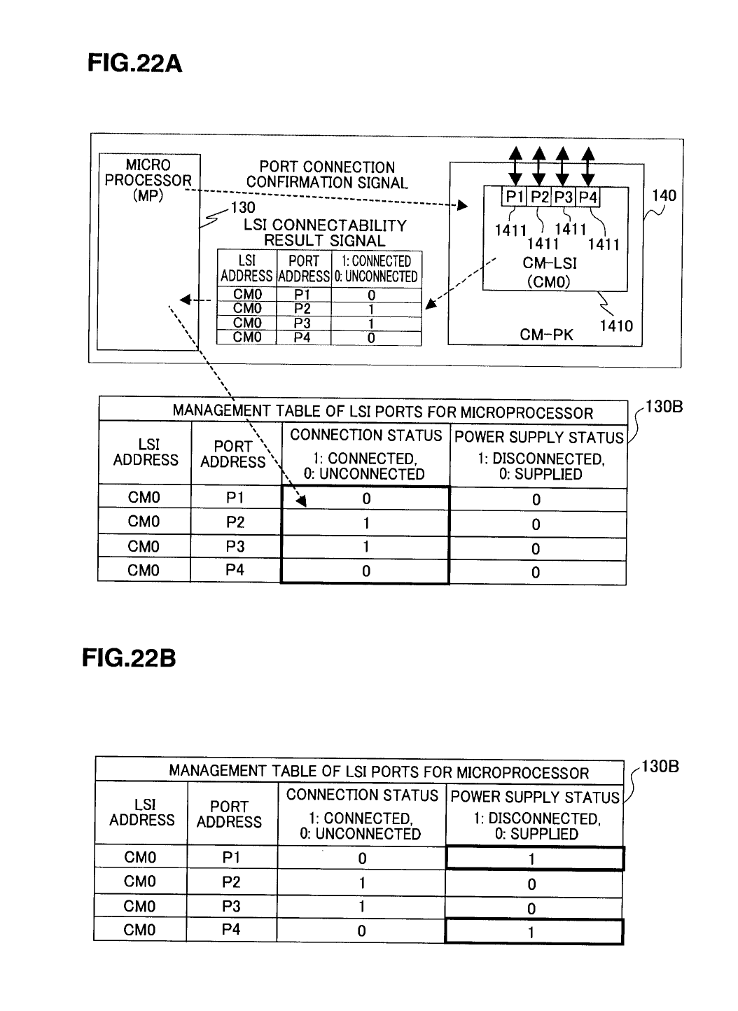

Firstly, the microprocessor 130, as shown in FIG. 22A, transmits a port connection confirmation signal to the CM-LSI 1410 (SP 401). The CM-LSI 1410, as shown in FIG. 22A, when receiving the port connection confirmation signal, causes the ports included in the relevant LSI to confirm the connection, and transmits the LSI connectibility result signal showing the result. This processing is omitted from the description here as it is the same as the CHA-LSI linkup processing.

The microprocessor 130, as shown in FIG. 22A, receives the LSI connectibility result signal (SP 402) and, with reference to the signal, registers the information on whether the ports in the CM-LSI 1410 are connected to the other ports in the connection status field of the microprocessor LSI port management table 130B (SP 403).

The microprocessor 130 transmits a power supply disconnection signal to the unconnected ports in the CM-LSI 1410 (SP 404). The CM-LSI 1410 including the unconnected ports, when receiving the power supply disconnection signal, disconnects the power supply in the unconnected ports, and transmits a power supply disconnection completion signal to the microprocessor 130.

The microprocessor 130 receives the power supply disconnection completion signal (SP 405) and, as shown in FIG. 22B, sets the power supply status field for the unconnected ports in the microprocessor LSI port management table 130B to “1: Disconnected” (SP 406), and the processing returns to the table creation processing.

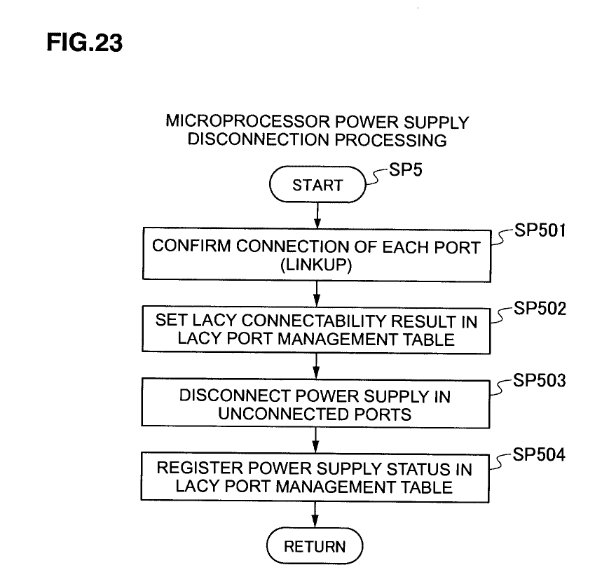

Next, the above-mentioned microprocessor power supply disconnection processing (SP 5) is described in details with reference to FIG. 23.

Firstly, the microprocessor 130 causes the ports included in the MP-LSI 1310 to confirm the connection (SP 501), and then registers the information on whether the ports in the MP-LSI 1310 are connected to the other ports in the connection status field of the microprocessor LSI port management table 130B (SP 502).

The microprocessor 130 disconnects the power supply in the unconnected ports in the MP-LSI 1310 (SP 503), sets the power supply status field for the unconnected ports in the microprocessor LSI port management table 130B to “1: Disconnected” (SP 504), and the processing returns to the table creation processing.

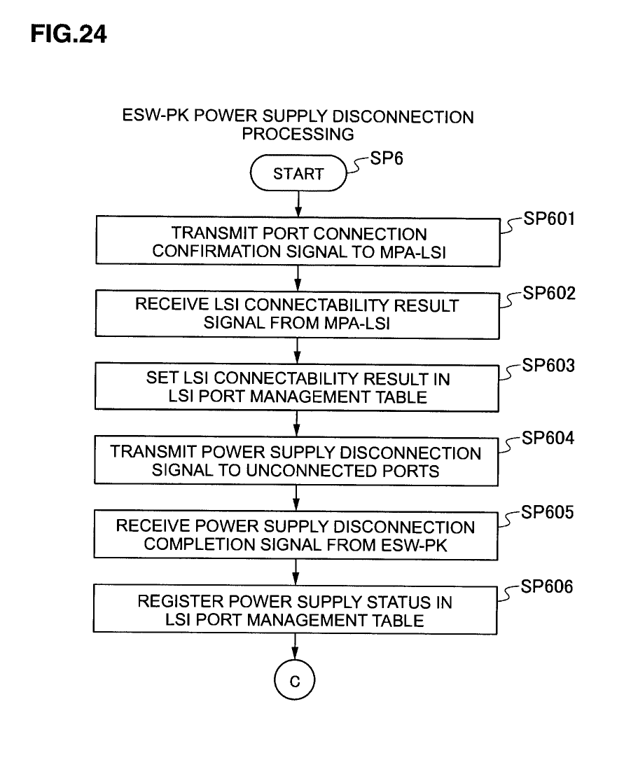

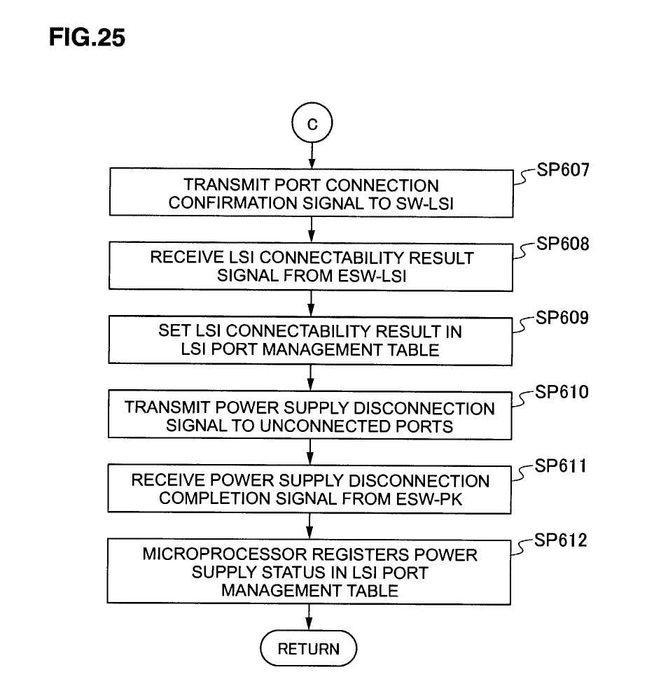

Next, the above-mentioned ESW-PK power supply disconnection processing (SP 6) is described in details with reference to FIGS. 24 and 25.

Firstly, the microprocessor 130 transmits a port connection confirmation signal to the MPA-LSI 1520 (SP 601). The MPA-LSI 1520, when receiving the port connection confirmation signal, causes the ports included in the relevant LSI to confirm the connection, and transmits an LSI connectibility result signal. This processing is omitted from the description here as it is the same as the CHA-LSI linkup processing.

The microprocessor 130 receives the LSI connectibility result signal (SP 602) and, with reference to the signal, registers the information on whether the ports in the MPA-LSI 1520 are connected to the other ports in the connection status field of the microprocessor LSI port management table 130B (SP 603).

The microprocessor 130 transmits a power supply disconnection signal to the unconnected ports in the MPA-LSI 1520 (SP604). The MPA-LSI 1520 including the unconnected ports, when receiving the power supply disconnection signal, disconnects the power supply in the unconnected ports, and transmits a power supply disconnection completion signal to the microprocessor 130.

The microprocessor 130 receives the power supply disconnection completion signal (SP 605), and sets the power supply status field for the unconnected ports in the microprocessor LSI port management table 130B to “1: Disconnected” (SP 606).

The microprocessor 130 transmits a port connection confirmation signal to the SW-LSI 1510 (SP 607). The SW-LSI 1510, when receiving the port connection confirmation signal, causes the ports included in the relevant LSI to confirm the connection, and transmits the LSI connectibility result signal showing the result. This processing is omitted from the description here as it is the same as the CHA-LSI linkup processing.

The microprocessor 130 receives the LSI connectibility result signal (SP 608) and, with reference to the signal, registers the information on whether the ports in the SW-LSI 1510 are connected to the other ports in the connection status field of the microprocessor LSI port management table 130B (SP 609).

The microprocessor 130 transmits a power supply disconnection signal to the unconnected ports in the SW-LSI 1510 (SP610). The SW-LSI 1510 including the unconnected ports, when receiving the power supply disconnection signal, disconnects the power supply in the unconnected ports, and transmits a power supply disconnection completion signal to the microprocessor 130.

The microprocessor 130 receives power supply disconnection completion signal (SP 611), and sets the power supply status field for the unconnected ports in the microprocessor LSI port management table 130B to “1: Disconnected” (SP 612), and the processing returns to the table creation processing.

As mentioned above, by the CHK-PK power supply disconnection processing, the DKA-PK power supply disconnection processing, the CM-PK power supply disconnection processing, the MP power supply disconnection processing, and the ESW-PK power supply disconnection processing, the connection status (connected or unconnected) of the interfaces in these packages can be detected, and the power supply in the unconnected ports can be disconnected.

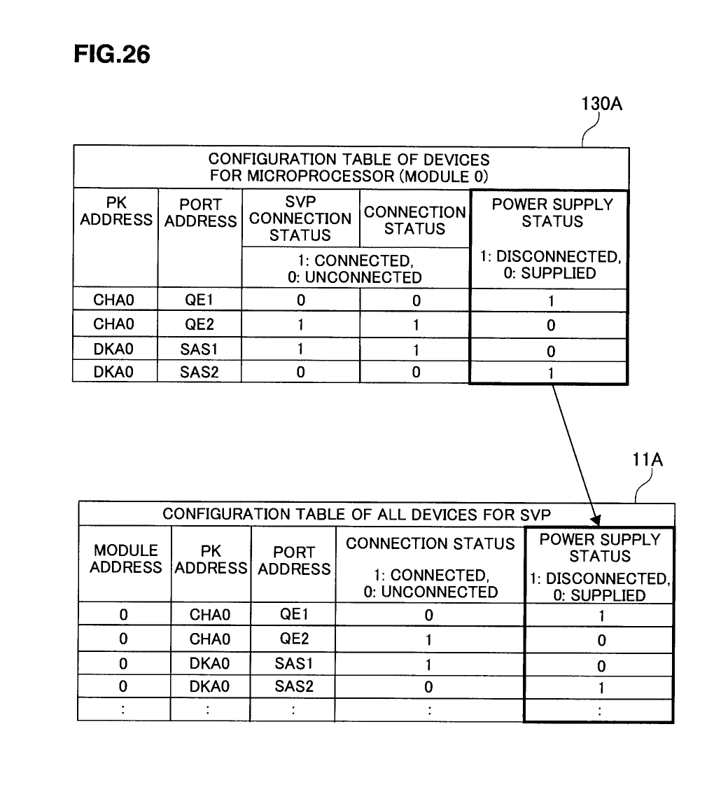

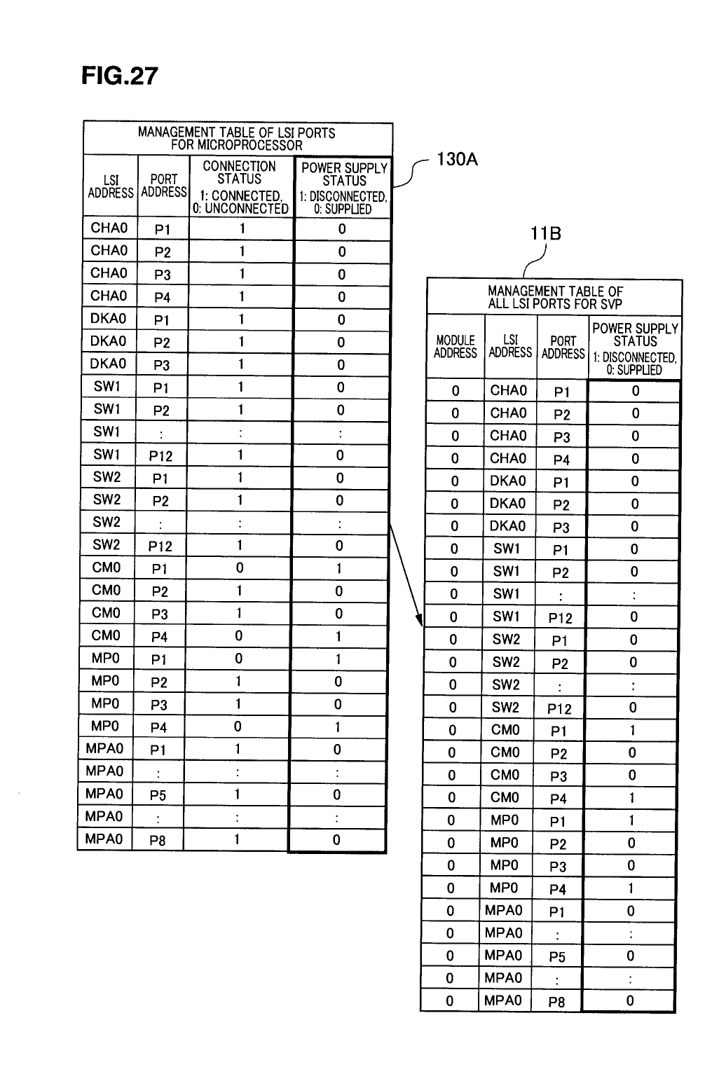

Finally, by the table creation processing SP7, the microprocessor 130, as shown in FIG. 26, transmits the information of the power supply status field in the microprocessor device configuration table 130A to the SVP 11, and reflects it in the power supply status field of the SVP all-devices configuration table 11A. The microprocessor 130, as shown in FIG. 27, also transmits the information of the power supply status field in the microprocessor device configuration table 130B to the SVP 11, and reflects it in the power supply status field of the SVP all-devices configuration table 11B.

As mentioned above, the user can ascertain the information of the host terminals 3 and the hard disks 20 connected to the disk controller 1 and the information of the ports in the packages in the disk controller 1 whose power supply is disconnected.

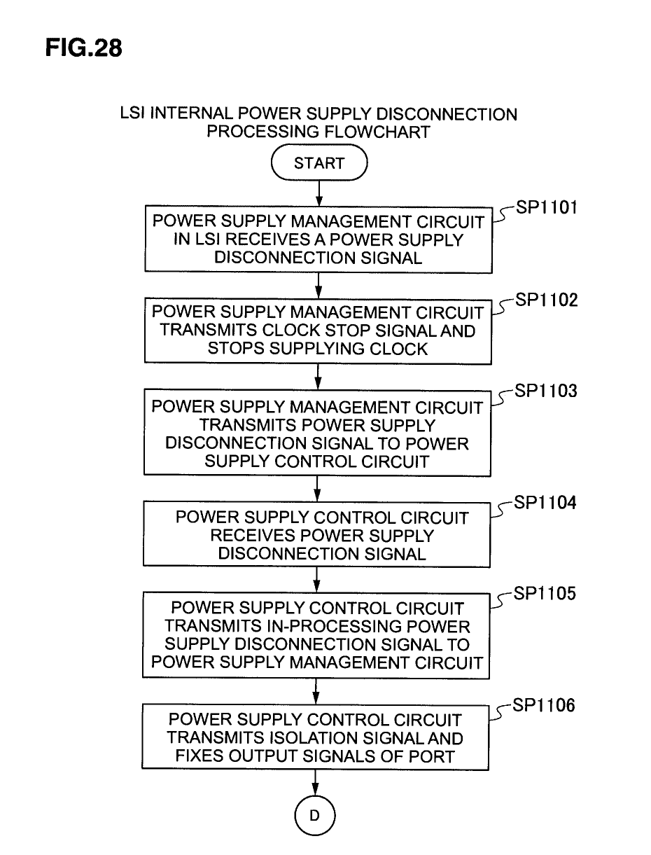

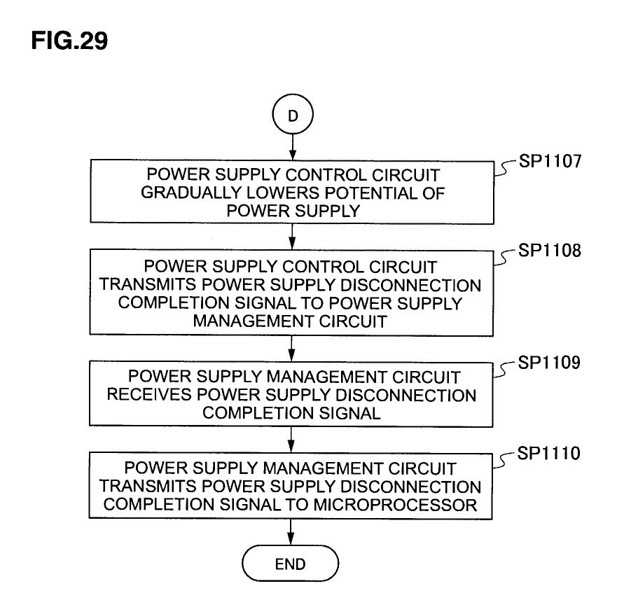

Next, the LSI internal power supply disconnection processing by which each LSI disconnects the power supply of the internal ports is described below with reference to FIGS. 28 and 29. At this point, the flowchart of a case where the SW-LSI 1510 of the LSI address “SW0” disconnects power supply in the port 1511 of the port address “P1” is described.

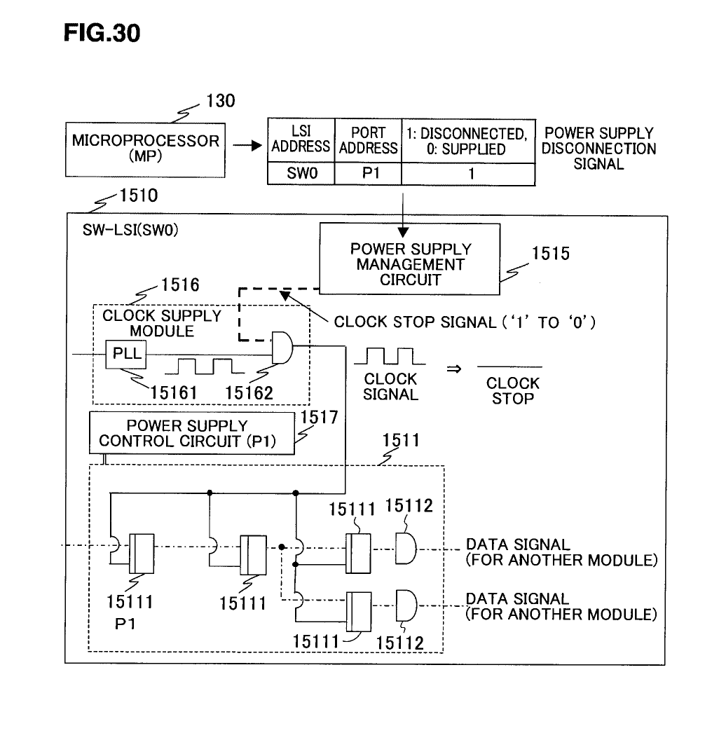

Firstly, when the power supply management circuit 1515 in the SW-LSI 1510, as shown in FIG. 30, receives a power supply disconnection signal from the microprocessor 130 (SP1101), transmits a clock stop signal to the AND gate 15162, and stops supplying clock signals to the ports 1511 (SP 1102). That is, by changing the input by the power supply management circuit 1515 for the AND gate 15162 from “1” to “0,” the supply of clock signals is stopped.

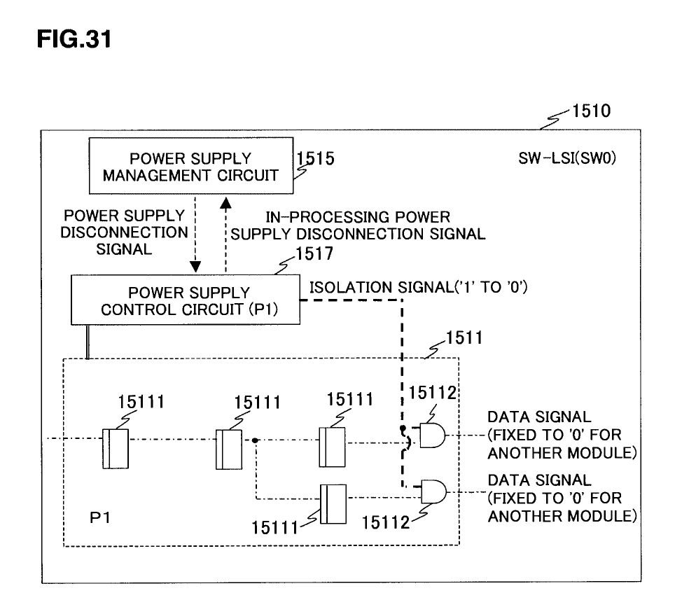

Next, the power supply management circuit 1515, as shown in FIG. 31, transmits a power supply disconnection signal to the power supply control circuit 1517 (SP 1103). The power supply control circuit 1517, when receiving the power supply disconnection signal (SP 1104), transmits an in-processing power supply disconnection signal to the power supply management circuit 1515 (SP 1105).

The power supply control circuit 1517 transmits an isolation signal to the AND gate 15162 and stops the output of data signals from the ports 1511 (SP 1106). That is, by changing the input by the power supply control circuit 1517 for the AND gate 15162 from “1” to “0,” the output of data signals is stopped.

The power supply control circuit 1517 gradually decreases the power supply to the power supply line shown in FIG. 9 and gradually lowers the potential of the power supply (SP 1107). When lowering the potential of the power supply is completed, a power supply disconnection completion signal is transmitted to the power supply management circuit 1515 (SP 1108).

The power supply management circuit 1515, when receiving the power supply disconnection completion signal (SP 1109) from the power supply control circuit 1517, transmits the power supply disconnection completion signal to the microprocessor 130 (SP 1110), and completes the processing.

As mentioned above, according to the LSI internal power supply disconnection processing, the supply of clock signals to the ports in the LSI can be stopped, the output of data signals can be stopped, and the power supply can be disconnected. Though this document refers to and describes the case of the SW-LSI 1510 of the LSI address “SW0” and the port 1511 of the port address “P1,” it is obvious that the processing can be applied to the other ports.

Next, the power supply disconnection processing for the ports which become unconnected due to removal when hard disks 20 or host terminals 3 are removed from the disk controller 1 is described below.

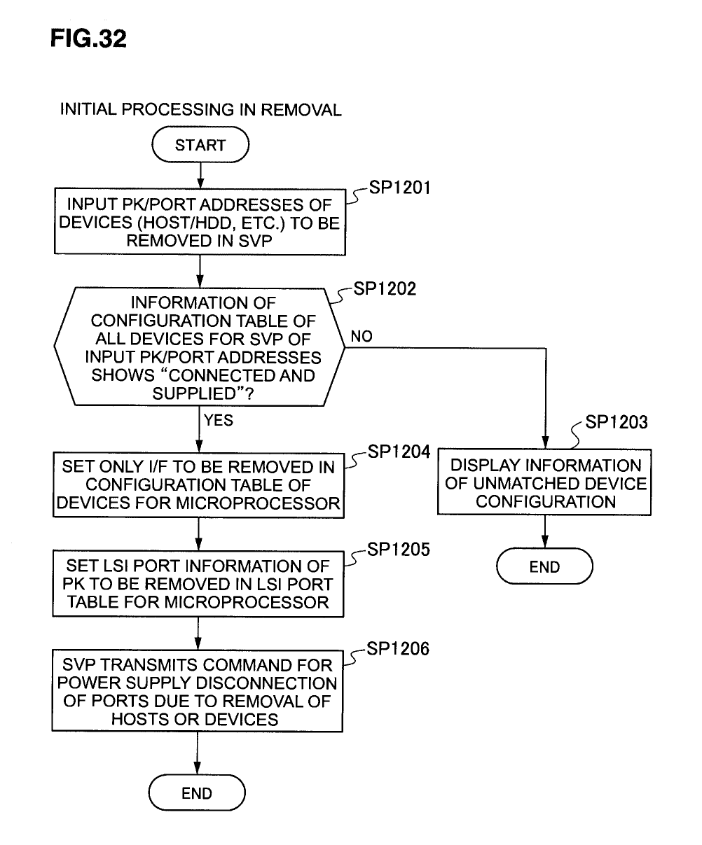

Firstly, the initial processing in removal performed by the SVP 11 when hard disks 20 or host terminals 3 are removed is described below with reference to FIG. 32.

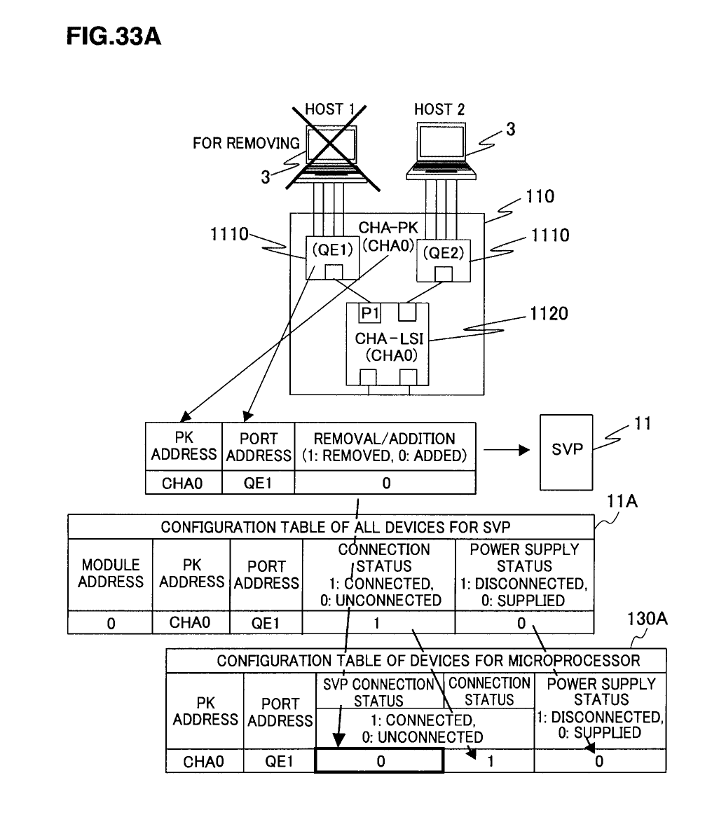

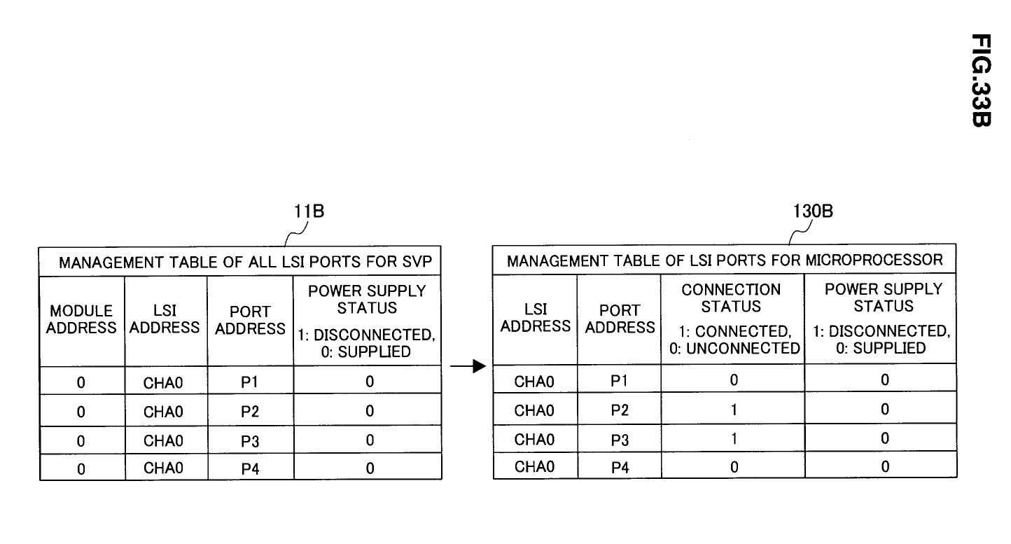

The user, when removing devices or hosts, as shown in the example of FIG. 33A, inputs the address of the PK to which the removed devices are connected, the address of the port to which the relevant devices are connected, and the flag for removal, and the SVP 11 accepts the information (SP 1201).

The SVP 11 refers to the SVP all-devices configuration table 11A and determines whether the connection status field and the power supply status of the port including the PK address and the port address input at SP 1201 are “1: Connected” and “0: Supplied” respectively or not (SP 1202).

If the connection status field and the power supply status of the port are not “1: Connected” and “0: Supplied” respectively (SP 1202; NO), the SVP 11 displays the information of the unmatched device configuration that the actual device configuration does not match the configuration before the removal (SP 1203), and completes the processing.

If the connection status field and the power supply status are “1: Connected” and “0: Supplied” respectively (SP 1202; YES), the SVP 11, as shown in the example of FIG. 33A, creates the microprocessor device configuration table 130A for the interfaces whose devices or hosts are removed in the microprocessor 130, sets the SVP connection status to “0: Unconnected,” and registers the information of the connection status and the power supply status in the SVP all-devices configuration table 11A in the connection status field and the power supply field in the table 130A (SP 1204).

The SVP 11, as shown in FIG. 33B, creates the microprocessor LSI port management table 130B for the LSI in the package where devices or hosts are removed in the microprocessor 130 (SP 1205). The SVP 11 transmits a command for the power supply disconnection of the ports disconnected due to the removal of hosts or devices to the microprocessor 130 (SP 1206), and completes the processing.

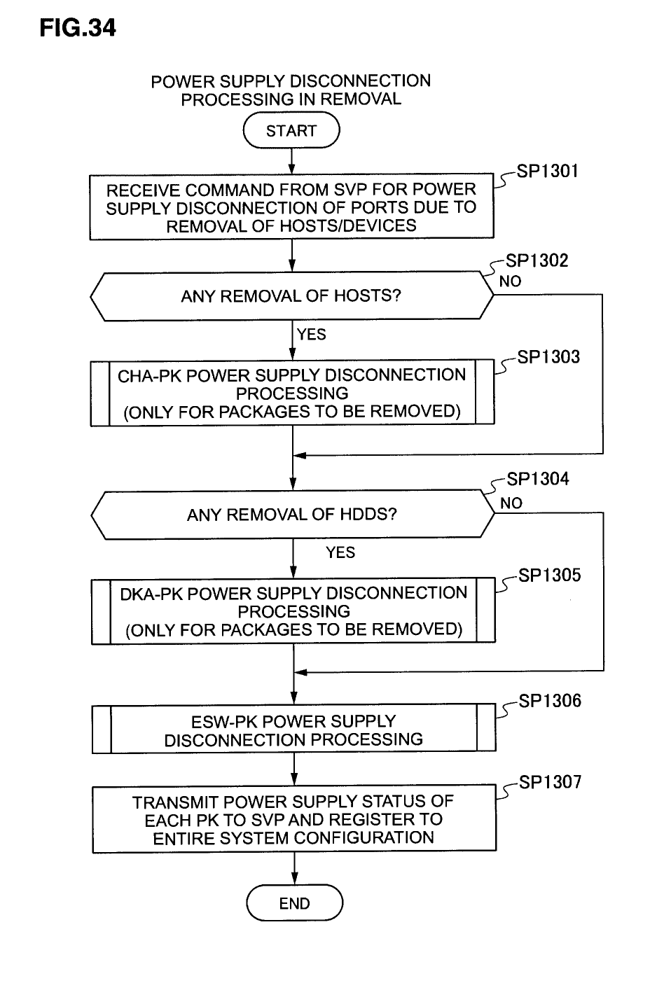

Next, the power supply disconnection processing performed by the microprocessor 130 for the ports whose power is disconnected due to the removal of hosts or devices is described below with reference to FIG. 34.

The microprocessor 130, when receiving a command from the SVP 11 for the power supply disconnection of the ports whose power supply is disconnected due to the removal of hosts or devices (SP 1301), determines whether any hosts (host terminals 3) are removed (SP 1302).

If no host is removed (SP 1302; NO), the microprocessor 130 proceeds to SP 1304.

If any hosts are removed (SP 1302; YES), the microprocessor 130 performs the CHA-PK power supply disconnection processing only for the CHA-PK 110 where hosts are removed (SP 1303). The power supply disconnection processing for this CHA-PK 110 is nearly the same as the CHA-PK power supply disconnection processing at the time of a new start-up, and is omitted from the description here.

Next, the microprocessor 130 determines whether any devices (hard disks 20) are removed (SP 1304).

If no device is removed (SP 1304; NO), the microprocessor 130 proceeds to SP 1306.

If any devices are removed (SP 1304; YES), the microprocessor 130 performs the DKA-PK power supply disconnection processing only for the DKA-PK 120 where devices are removed (SP 1305). This DKA-PK power supply disconnection processing is nearly the same as the DKA-PK power supply disconnection processing at the time of a new start-up, and the description for the same is omitted here.

The microprocessor 130 performed the ESW-PK power supply disconnection processing (SP 1306). This ESW-PK disconnection processing is nearly the same as the ESW-PK power supply disconnection processing at the time of a new start-up, and is omitted from the description here.

The microprocessor 130 transmits the information of the microprocessor device configuration table 130A and the microprocessor LSI port management table 130B to the SVP 11, reflects the information on the SVP all-devices configuration table 11A and the SVP all-LSI ports configuration table 11B (SP 1307), and completes the processing.

The above-mentioned methods can, when removing hosts or devices, disconnect the power supply in the ports to be unconnected due to the removal.

Next, the processing of, when hard disks 20 or host terminals 3 are added to the disk controller 1, supplying power to the ports connected due to the addition is described below.

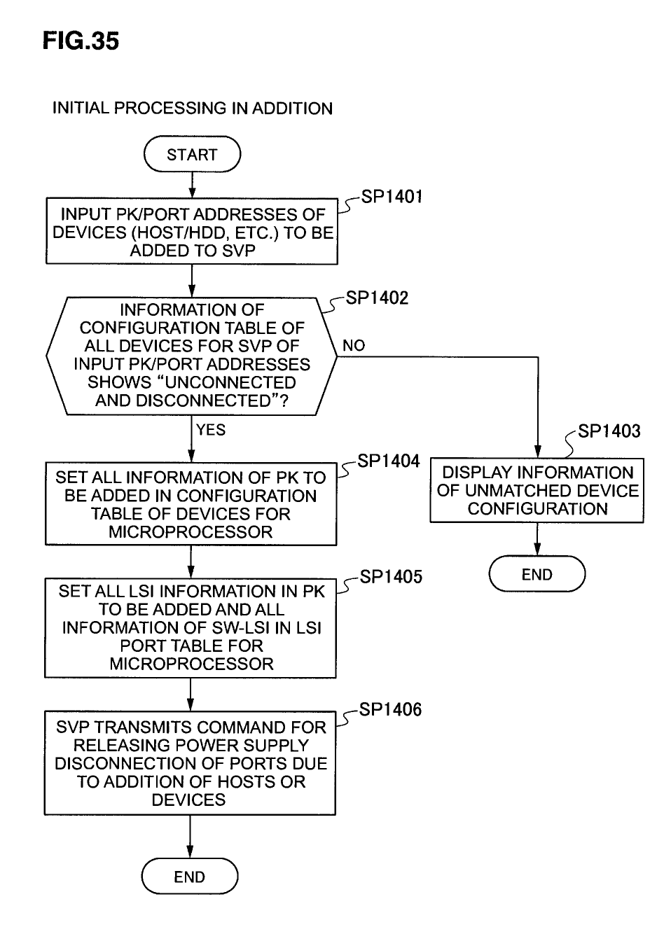

Firstly, the initial processing in addition performed by the SVP 11 when adding hard disks 20 or host terminals 3 is described below with reference to FIG. 35.

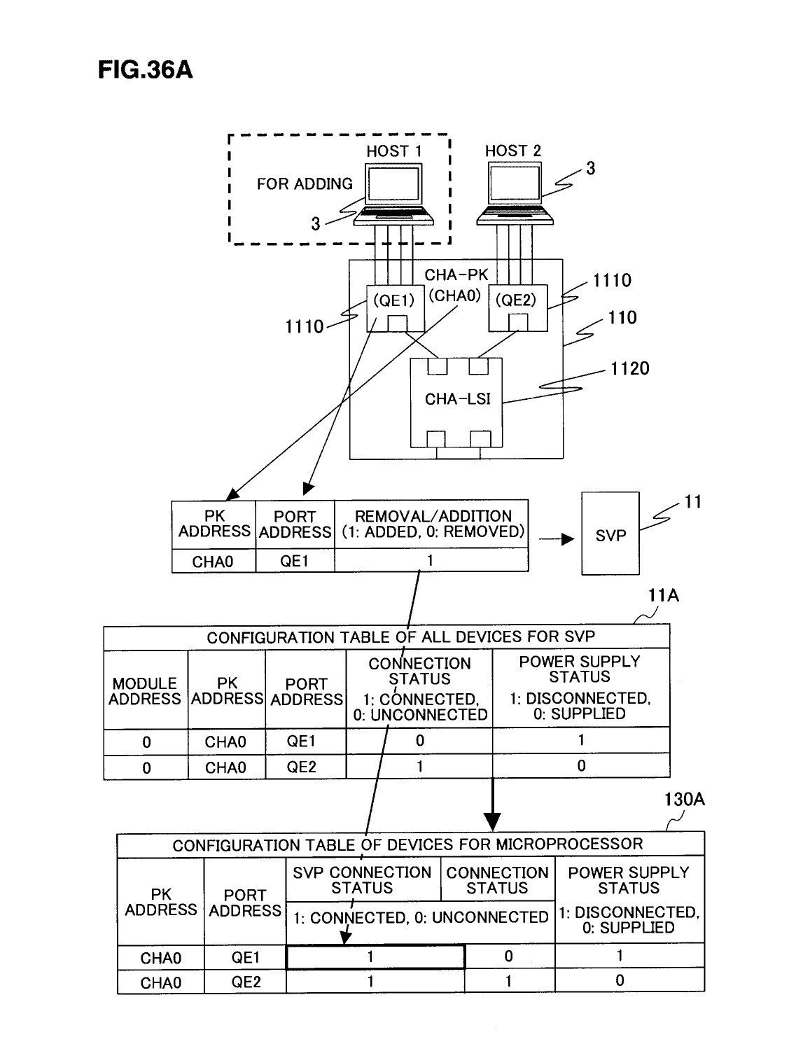

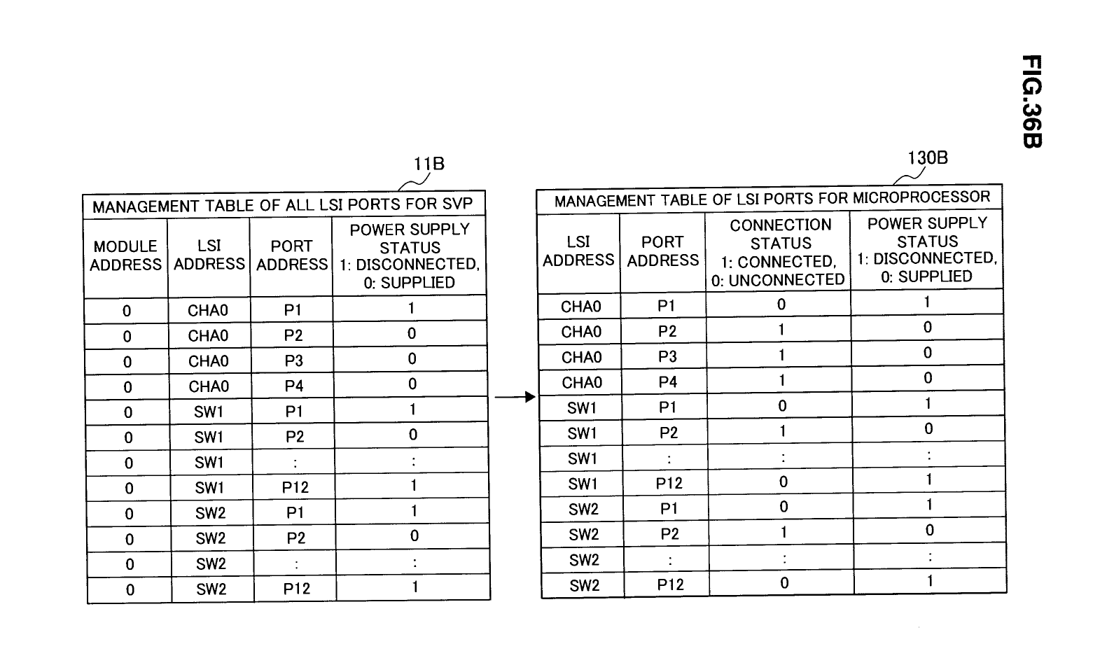

The user, when adding devices or hosts, as shown by the example in FIG. 36A, inputs the address of the PK to which additional devices are connected, the address of the port to which the relevant devices are connected, and the flag for addition to the SVP 11, and the SVP 11 accepts the information (SP 1401).

The SVP 11 refers to the SVP all-devices configuration table 11A and determines whether the connection status field and the power supply status of the port including the PK address and the port address input at SP 1401 are “0; Unconnected” and “1; Disconnected” respectively or not (SP 1402).

If the connection status field and the power supply status field of the port are not “0; Unconnected” and “1; Disconnected” respectively (SP 1402; NO), the SVP 11 displays the information of the unmatched device configuration that the actual device configuration does not match the device configuration before the addition (SP 1403), and completes the processing.

If the connection status field and the power supply status are “0; Unconnected” and “1; Disconnected” respectively (SP 1402; YES), the SVP 11, as shown in the example of FIG. 36A, creates the microprocessor device configuration table 130A for the interfaces whose devices or hosts are added in the microprocessor 130, sets the SVP connection status to “1; Connected,” and registers the information of the connection status and the power supply status in the SVP all-devices configuration table 11A in the connection status field and the power supply field in the table 130A (SP 1404).

The SVP 11, as shown by the example in FIG. 36B, creates the microprocessor LSI port management table 130B for the LSI in the package where devices or hosts are added in the microprocessor 130 (SP 1405). The SVP 11 transmits a command for the power supply of the ports connected due to the addition of hosts or devices to the microprocessor 130 (SP 1406), and completes the processing.

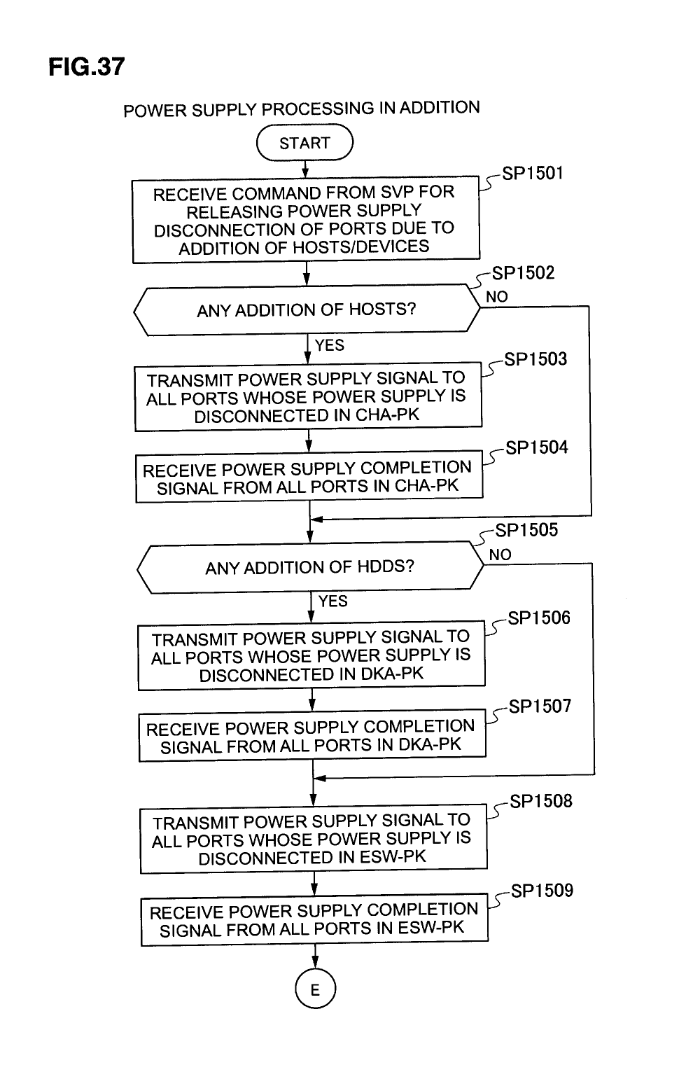

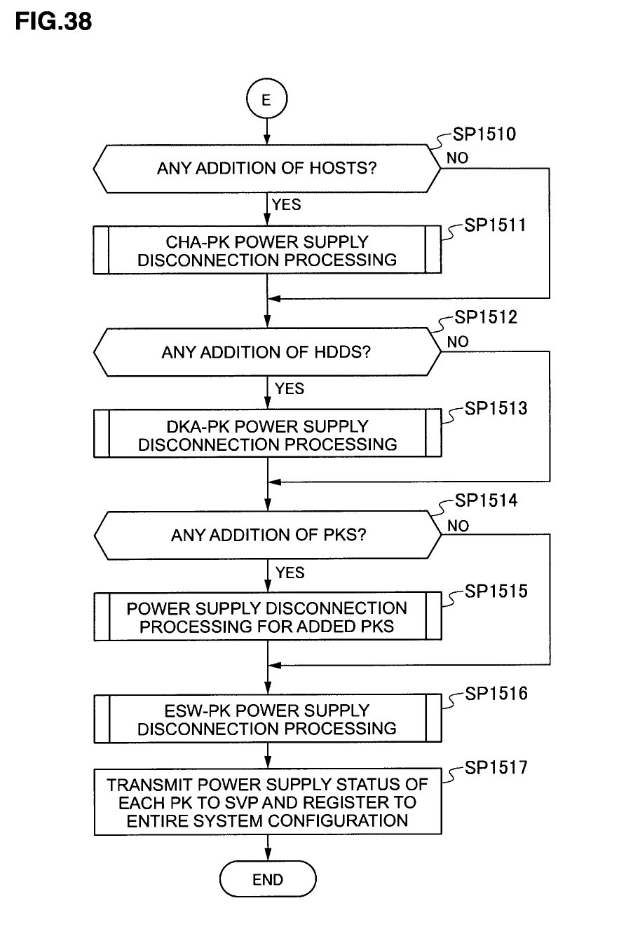

Next, the power supply processing in addition performed by the microprocessor 130 of supplying power for the ports to be connected due to the addition of hosts or devices is described below with reference to FIGS. 37 and 38.

The microprocessor 130, when receiving a command from the SVP 11 for the power supply for the ports to be connected due to the addition of hosts or devices (SP 1501), determines whether any hosts (host terminals 3) are added (SP 1502).

If there is no addition of hosts (5P1502; NO), the microprocessor 130 proceeds to SP 1505.

If any hosts are added (SP 1502; YES), the microprocessor transmits a power supply signal to all the ports whose power supply is disconnected in the CHA-PK 110 where hosts are added (SP 1503). The CHA-PK 110 where hosts are added, when receiving the power supply signal, starts the power supply for all the ports whose power supply is disconnected, and transmits a power supply completion signal to the microprocessor 130.

The microprocessor 130, when receiving the power supply completion signal from the CHA-PK 110 where hosts are added (SP 1504), determines whether any devices (hard disks 20) are added (SP 1505).

If no device is added (SP 1505; NO), the microprocessor 130 proceeds to SP 1508.

If any devices are added (SP 1505; YES), the microprocessor 130 transmits a power supply signal to all the ports whose power supply is disconnected in the DKA-PK 120 where devices are added (SP 1506).

The DKA-PK 120 where devices are added, when receiving the power supply signal, starts the power supply for all the ports whose power supply is disconnected, and transmits a power supply completion signal to the microprocessor 130.

The microprocessor 130, when receiving the power supply completion signal from the DKA-PK 120 where hosts are added (SP 1507), transmits a power supply signal to all the ports whose power supply is disconnected in the ESW-PK 150 (SP 1508). The ESW-PK 150, when receiving the power supply signal, starts the power supply for all the ports whose power supply is disconnected, and transmits a power supply completion signal to the microprocessor 130.

The microprocessor 130, when receiving the power supply completion signal from the ESW-PK 150 (SP 1509), determines whether any hosts (host terminals 3) are added (SP 1510).

If no host is added (SP 1510; NO), the microprocessor 130 proceeds to SP 1512.

If any hosts are added (SP 1510; YES), the microprocessor 130 performs the CHA-PK power supply disconnection processing (SP 1511). This CHA-PK power supply disconnection processing is the same as the CHA-PK power supply disconnection processing at the time of a new start-up, and is omitted from the description here.

Next, the microprocessor 130 determines whether any devices (hard disks 20) are added or not (SP 1512).

If no device is added (SP 1512; NO), the microprocessor 130 proceeds to SP 1514.

If any devices are added (SP 1512; YES), the microprocessor 130 performs the DKA-PK power supply disconnection processing (SP 1513). This DKA-PK power supply disconnection processing is the same as the DKA-PK power supply disconnection processing at the time of a new start-up, and is omitted from the description here.

The microprocessor 130 determines whether any packages are added or not (SP 1514).

If no package is added (SP 1514; NO), the microprocessor 130 proceeds to SP 1516.

If any packages are added (SP 1514; YES), the microprocessor 130 performs the power supply disconnection processing for the added packages (SP 1515). This power supply disconnection processing is any one of the CHK-PK power supply disconnection processing, the DKA-PK power supply disconnection processing, the CM-PK power supply disconnection processing, the microprocessor power supply disconnection processing, and the ESW-PK power supply disconnection processing, and the description is omitted here.

Next, the microprocessor 130 performs the ESW-PK power supply disconnection processing (SP 1516). This ESW-PK power supply disconnection processing is the same as the ESW-PK power supply disconnection processing at the time of a new start-up, and is omitted from the description here.

The microprocessor 130 transmits the information of the microprocessor device configuration table 130A and the microprocessor LSI port management table 130B to the SVP 11, reflects the information on the SVP all-devices configuration table 11A and the SVP all-LSI ports configuration table 11B (SP 1517), and completes the processing.

The above-mentioned methods can, when adding hosts or devices, supply power for the ports to be connected due to the addition.

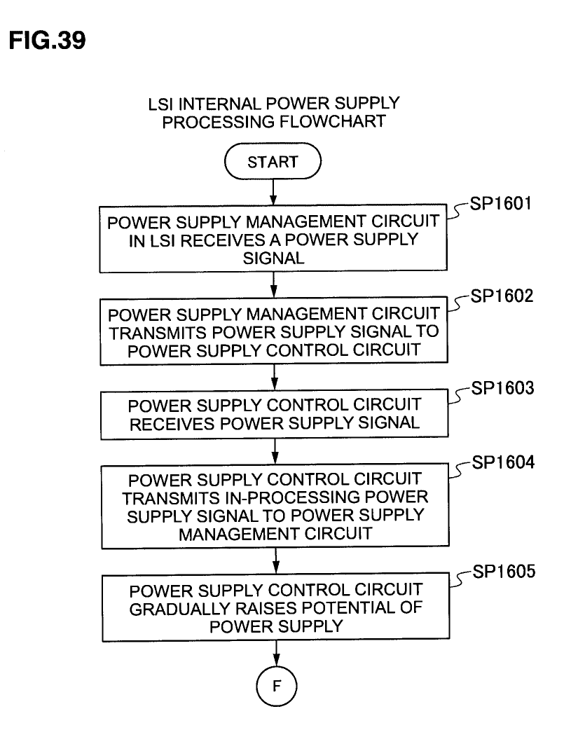

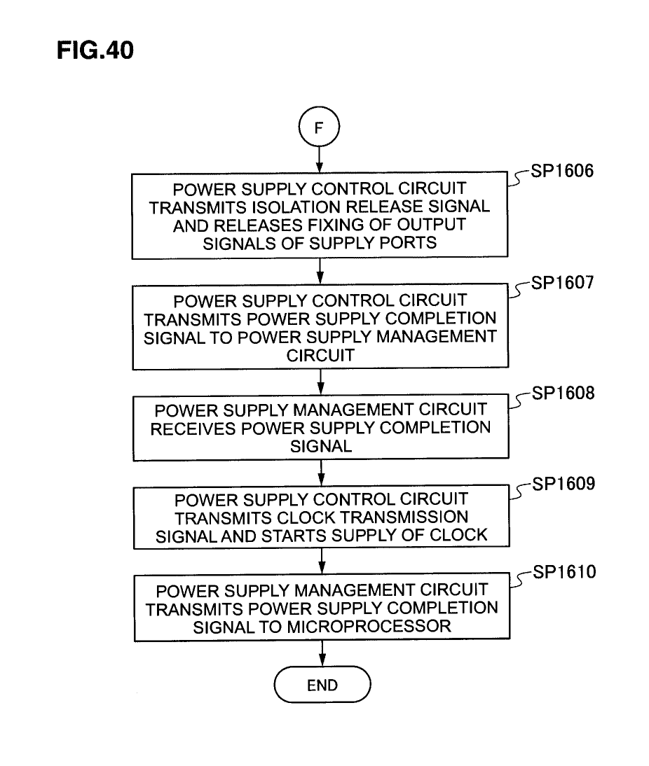

Next, the LSI internal power supply processing performed by each LSI of supplying power to the internal ports is described below with reference to FIGS. 39 and 40. At this point, the flowchart of the case where the SW-LSI 1511 of the LSI address “SW0” supplies power to the port 1511 of the port address “P1” is described.

Firstly, the power supply management circuit 1515 in the SW-LSI 1510, when receiving a power supply signal from the microprocessor 130 (SP 1601), transmits the power supply signal to the power supply control circuit 1517 (SP 1602).

The power supply control circuit 1517, when receiving the power supply signal (SP 1603), transmits an in-processing power supply signal to the power supply management circuit 1515 (SP 1604).

The power supply control circuit 1517 gradually increases the power supply to the power supply line shown in FIG. 9 and gradually raises the potential of the power supply (SP 1605). When raising the potential of the power supply is completed, an isolation release signal is transmitted to the AND gate 15112, and the output of data signals from the port 1511 is started (SP 1606). That is, by setting the input to the AND gate 15112 from the power supply control circuit 1517 from “0” to “1,” the output of data signals is started.

The power supply control circuit 1517 transmits a power supply completion signal to the power supply management circuit 1515 (SP 1607).

The power supply management circuit 1515, when receiving the power supply completion signal from the power supply control circuit 1517 (SP 1608), transmits a clock transmission signal to the AND gate 15162 and starts the supply of clock signals to the port 1511 (SP 1609). That is, by setting the input to the AND gate 15162 from the power supply management circuit 1515 from “0” to “1,” the supply of clock signals is started.

The power supply management circuit 1515 transmits a power supply completion signal to the microprocessor 130 (SP 1610), and completes the processing.

As mentioned above, according to the LSI internal power supply disconnection processing, the power supply can be disconnected in the ports in the LSI, the output of data signals can be started, and the supply of clock signals can be started. Though this document refers to and describes the case of the SW-LSI 1510 of the LSI address “SW0” and the port 1511 of the port address “P1,” it is obvious that the processing can be applied to the other ports.

As mentioned above, the disk controller of this invention, at the time of a new start-up, detects ports not connected to any hosts or devices in the channel adapters and disk adapters and disconnects power supply in the detected unconnected ports, detects ports not connected to any other ports in the cache memory and disconnects power supply in the detected unconnected ports, detects ports not connected to any other ports in the microprocessor and disconnects power supply in the detected unconnected ports, and detects ports not connected to any other ports in the switch circuits and disconnects power supply in the detected unconnected ports.

By disconnecting power supply for unused ports, a significant amount of power consumption can be saved.

Furthermore, when removing hosts or devices for the disk controller, ports to be newly unconnected can be detected, and power supply can be disconnect in the detected unconnected ports.

By this method, in accordance with the connection status of the disk controller and the hosts or devices, power consumption can be appropriately saved.

Furthermore, when adding hosts or devices for the disk controller, ports newly connected can be detected, and the power supply for the detected connected ports can be started.

By this method, in accordance with the connection status of the disk controller and the hosts or devices, power consumption can be appropriately controlled.

### EXPLANATION OF REFERENCE NUMERALS

1 Disk controller
2 Disk unit
3 Host terminal
10 Module
11 System management processor (SVP)
11A Configuration table of all devices for the SVP
11B Management table of all LSI ports for the SVP
12 Management terminal
20 Hard disk
110 Channel adapter package
120 Disk adapter package
130 Microprocessor
130A Configuration table of the devices for the microprocessor
130B Management table of the LSI ports for the microprocessor
140 Cache memory package
150 Internal switch package
1110 Host interface
1111 Port
1120 Channel adapter LSI
1121, 1122 Port
1210 Disk interface
1211 Port
1220 Disk adapter LSI
1221, 1222 Port
1310 Microprocessor LSI
1311 Port
1410 Cache memory LSI
1411 Port
1510 Switch LSI
1511, 1512, 1513, 1514 Port
1520 Microprocessor adapter LSI
1521, 1522 Port

1. A storage controller connected to a host terminal and a storage device for controlling data in the storage device, comprising:
a plurality of components comprising one or more ports and configuring a data path between the host terminal and the storage device via the ports; and
a microprocessor comprising one or more ports and for controlling the components via the ports;
wherein the microprocessor detects an unconnected port among the ports of the microprocessor or the component that is not connected to a port of the host terminal, the storage device, or another component, and stops the supply of power to the detected unconnected port.

2. The storage controller according to claim 1,
wherein one component comprises:
a host interface comprising a port and connected to the host terminal via the port; and
a channel adapter control circuit comprising a port and for controlling the connection between the host interface and another component via the port;
wherein the microprocessor detects the port of the host interface that is not connected to the host terminal as an unconnected port, and stops the supply of power to the detected unconnected port; and
wherein the microprocessor causes a port of the channel adapter control circuit to send data to a port of the host interface or a port of another component, detects a port from which a response is not received as an unconnected port, and stops the supply of power to the detected unconnected port.

3. The storage controller according to claim 2 comprising one or more of the host interfaces;
wherein, if the microprocessor detects ports of all of the host interfaces as unconnected ports, the microprocessor detects all ports of the channel adapter control circuit as unconnected ports, and stops the supply of power to the ports.

4. The storage controller according to claim 1,
wherein one component comprises:
a disk interface comprising a port and connected to the storage device via the port; and
a disk adapter control circuit comprising a port and for controlling the connection between the disk interface and another component via the port;
wherein the microprocessor detects the port of the disk interface that is not connected to the storage device as an unconnected port, and stops the supply of power to the detected unconnected port; and
wherein the microprocessor causes a port of the disk adapter control circuit to send data to a port of the disk interface or a port of another component, detects a port from which a response is not received as an unconnected port, and stops the supply of power to the detected unconnected port.

5. The storage controller according to claim 4 comprising one or more of the disk interfaces;
wherein, if the microprocessor detects ports of all of the disk interfaces as unconnected ports, the microprocessor detects all ports of the disk adapter control circuit as unconnected ports, and stops the supply of power to the ports.

6. The storage controller according to claim 1,
wherein one component comprises:
a cache memory comprising a port and for temporarily storing data via the port for access from the host terminal to the storage device;
wherein the microprocessor causes a port of the cache memory to send data to a port of another component, detects a port from which a response is not received as an unconnected port, and stops the supply of power to the detected unconnected port.

7. The storage controller according to claim 1,
wherein the microprocessor causes a port of the microprocessor to send data to a port of another component, detects a port from which a response is not received as an unconnected port, and stops the supply of power to the detected unconnected port.

8. The storage controller according to claim 1,
wherein one component comprises:
a switch control circuit comprising a port and for controlling the connection between the channel adapter control circuit or the disk adapter control circuit and the cache memory via the port; and
a microprocessor adapter control circuit comprising a port and for controlling the connection between the switch control circuit and the microprocessor via the port;
wherein the microprocessor causes a port of the microprocessor adapter control circuit to send data to a port of the switch control circuit or the microprocessor, detects a port from which a response is not received as an unconnected port, and stops the supply of power to the detected unconnected port; and
wherein the microprocessor causes a port of the switch control circuit to a port of the channel adapter control circuit, the disk adapter control circuit or the cache memory, detects a port from which a response is not received as an unconnected port, and stops the supply of power to the detected unconnected port.

9. The storage controller according to claim 1,
wherein the microprocessor causes each component to send an address of the component, an address of the port and a table which associates the connection status thereof, creates an address of the component, an address of the port and a table which associates the connection status thereof based on the table received from each component, and stops the supply of power to a port in which the connection status indicated in the created table is unconnected.

10. A power saving method of a storage controller for controlling data in a storage device and comprising a plurality of components comprising one or more ports and configuring a data path between the host terminal and the storage device via the ports, and a microprocessor comprising one or more ports and for controlling the components via the ports,
wherein the microprocessor comprises:
a step of detecting an unconnected port among the ports of the microprocessor or the component that is not connected to a port of the host terminal, the storage device, or another component; and
a step of stopping the supply of power to the detected unconnected port.
